(19) United States
(12) Patent Application Publication
(10) Pub. No.: US 2006/0136350 A1
(43) Pub. Date: Jun. 22, 2006

(54) Space time continuum intercept detection system

(76) Inventor: George Gregory Jackson, Draper, UT (US)

Correspondence Address: GEORGE G. JACKSON, P.O. BOX 18, DRAPER, UT, 84020, US

(21) Appl. No.: 10/898,212

(22) Filed: Nov. 26, 2004

(51) Int. Cl. G06N 5/02; G06F 7/00

(52) U.S. Cl. 706/46; 707/100

(57) ABSTRACT

Process for space time detection with the past, present and future using factual real life objects, actions and events allowing for desired actions. The process can run on any chosen computer system or software using file or database formats containing the object information or can be processed with human intellect without computers. Information is entered into a file or database system with automated or manual methods storing the date and time of the objects being people, places and things. The objects locations and surroundings are mapped and stored. Information about the objects are obtained and if not on file they are entered. A recognition process is then used to decode variations of the object information and written to storage. As each record is stored an automated monitoring, reporting alarm and analysis process is then available for human or computer analysis allowing for any preprogrammed or chosen action.

I, George Gregory Jackson have invented a new process for a space time continuum intercept detection system.

This process detects events and actions that have occurred in the past or will occur in the present or future and interact with the past, present and future to detect and reveal actions in space and time that may have not been detected or revealed otherwise allowing for a desired actions.

This process is non-fictional and is composed of real life activities that occur each and every day. “Space Time Continuum Intercept Detection System” as set forth in the following

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention process method refers to methods for processing space and time.

I invented this process to allow for human analysis or computerized processing because of the minute or vast amount of information in making this invention work. The initial design and idea for making this process came from my own experiences when I realized that time and space were continuing to evolve and interact in a systematic process. I know of no other prior inventions that pertain to this process. Initially it almost drove me to insanity until I decoded and applied this process which is now my guard and weapon to many evil things that occur along life's time.

This invention is designed more to uncover past evil systematic actions in which living things were subjected to and to take action against present and future events and actions that are to occur. It can be used for numerous things though it is not my desire to use this process to harm or deprive living things of any right and joy of life that all inhabitants of creation should be entitled to.

### BRIEF SUMMARY OF THE INVENTION

1. The Space Time Continuum Intercept Detection System process is a computerized system as this process shows. The process can also be used by human instead of or in conjunction with the computerized process. When a computer is unavailable this design process allows for use in manual human format using the same methodical process. This design process allows for it to be run on just about any computer operating system and language and hardware with various file and database formats and application software.

2. There are six processes with detailed sub components that make this system process possible. The six processes continue until all or selected objects in a space and time are processed as described in FIG. 1 Summary Process Flow, FIG. 2 Detail Process Flow, FIG. 3 Summary Process Description, FIG. 4 Detailed Process Description.

3. It is an object of this invention to load history information into the database and file systems.

4. It is another object of this invention to use a central or segmented file or databases with object information and detailed decoded object information and expanded cross references.

5. Its another object of this invention to use a profile file or database to activate a desired action when a specified factor is detected by matching the profile variables entered in FIG. 7 to the results of the history in FIG. 8 indicating that past, present or future events are in process or have been detected.

6. It is another object of this invention to always be active adding new information via input output automated processes and or human interaction allowing for continuous information collection and analysis.

7. It is another object of this invention to allow the process to work with as little as a one object record entered manually with human interaction or with an infinite amount of objects entered with external input automated processes.

8. It is another object of this invention that as new object information is stored it is automatically processed and cross referenced based on the searchable detection profiles or key information programmed into the system in FIG. 7 as each record is processed in FIG. 4 process 5 and 6.

9. It is another object of this invention for a reporting and detection process that allows for automatic monitoring, reporting and alarming or for direct human interaction querying and analysis allowing for any desired action.

10. It is an object of this invention to detect things that will occur instead of just detecting things that could just possibly occur.

11. It is an object of this invention to process with a catalyst or without a catalyst and when a catalyst is used to decode the catalyst.

12. Examples in the DETAILED DESCRIPTION OF THE INVENTION describe numerous various uses of this invention.

### BRIEF DESCRIPTION OF THE SEVERAL VIEWS OF THE DRAWINGS

FIG. 1 Summary Process Flow 01 Page

FIG. 2 Detailed Process Flow 02 Pages

FIG. 3 Summary Process Description 01 Page

FIG. 4 Detailed Process Description 03 Pages

FIG. 5 Dictionary of Terms 01 Page

FIG. 6 Record Layouts 01 Page

FIG. 7 Profile File Contents 04 Pages

FIG. 8 History File Contents 35 Pages 5 pages wide per line.

FIG. 9 Sep. 7, 2001 17:34 Photo 01 Page

FIG. 10 Sep. 7, 2001 17:38 Photo 01 Page

FIG. 11 Sep. 7, 2001 17:39 Photo 01 Page

FIG. 12 Sep. 7, 2001 17:40 Photo 01 Page

FIG. 13 Sep. 7, 2001 17:46 Photo 01 Page

FIG. 14 Sep. 7, 2001 18:19 Photo 01 Page

FIG. 15 Sep. 7, 2001 18:21 Photo 01 Page

FIG. 16 Sep. 7, 2001 18:22 Photo 01 Page

FIG. 17 Sep. 7, 2001 18:23 Photo 01 Page

FIG. 18 Sep. 7, 2001 18:26 Photo 01 Page

FIG. 19 Sep. 7, 2001 18:30 Photo 01 Page

FIG. 20 Sep. 7, 2001 18:34 Photo 01 Page

FIG. 21 Sep. 7, 2001 18:36 Photo 01 Page

FIG. 22 Sep. 7, 2001 18:36 Photo 01 Page

FIG. 23 Sep. 7, 2001 18:40 Photo 01 Page

FIG. 24 Sep. 7, 2001 18:48 Photo 01 Page

FIG. 25 Sep. 7, 2001 19:40 Photo 01 Page

FIG. 26 Sep. 7, 2001 19:44 Photo 01 Page

FIG. 27 Nov. 11, 2001 14:04 Photo 01 Page

FIG. 28 1996 X-Ray 01 Page

FIG. 29 1998 Photo 01 Page

FIG. 30 Example 1 11 Pages

FIG. 31 Example 2 02 Pages

FIG. 32 Example 3 01 Page

FIG. 33 Example 4 03 Pages

FIG. 34 Example 5 02 Pages

FIG. 35 Example 6 01 Page

FIG. 36 Example 7 04 Pages

FIG. 37 Example 8 12 Pages

### DETAILED DESCRIPTION OF THE INVENTION

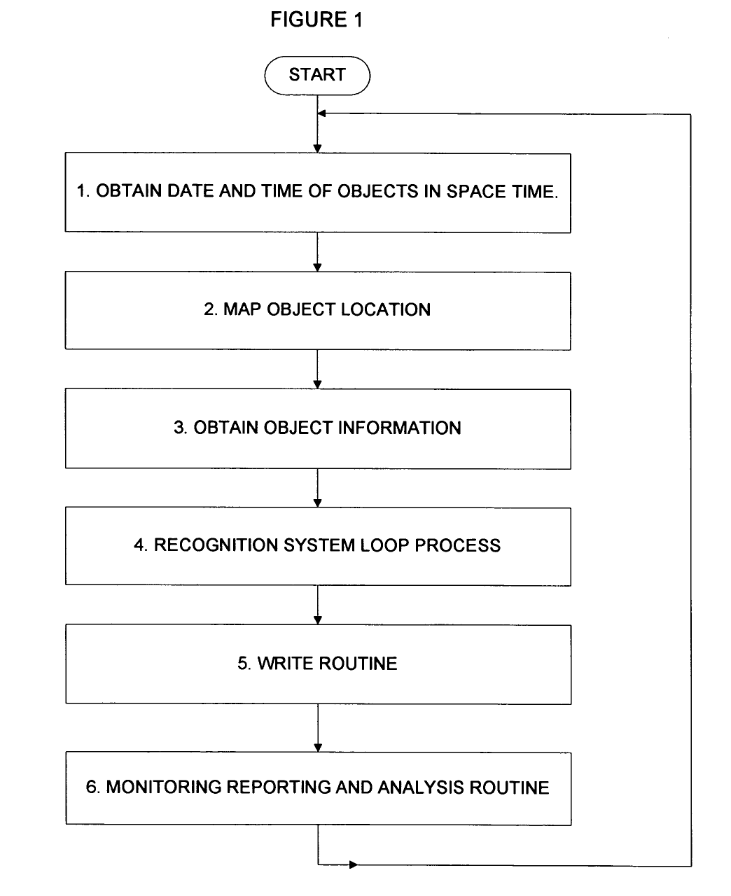

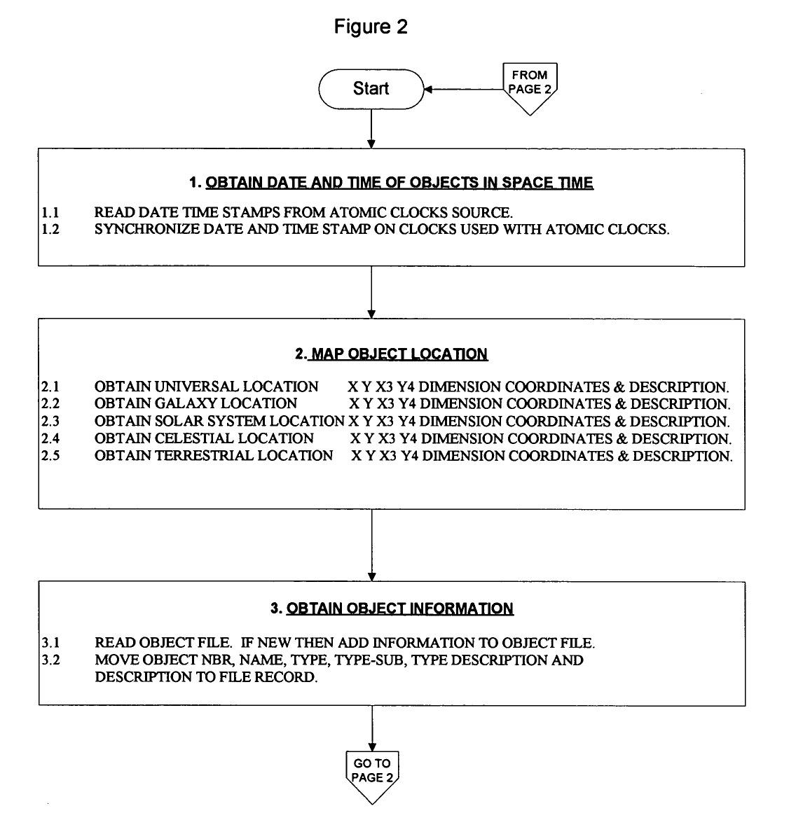

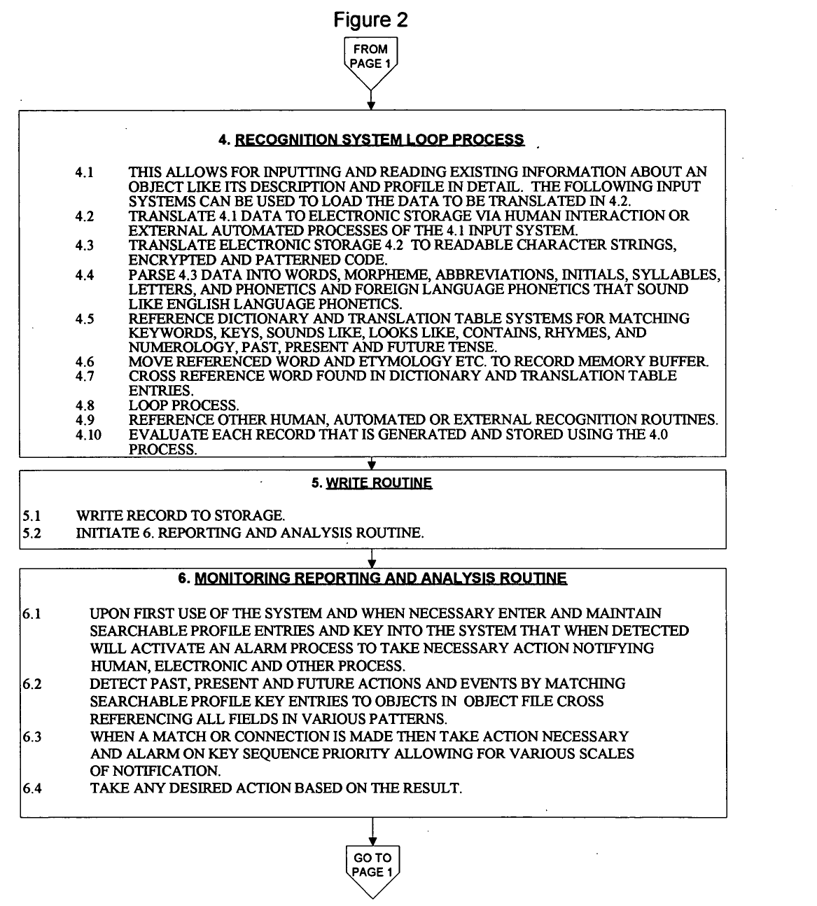

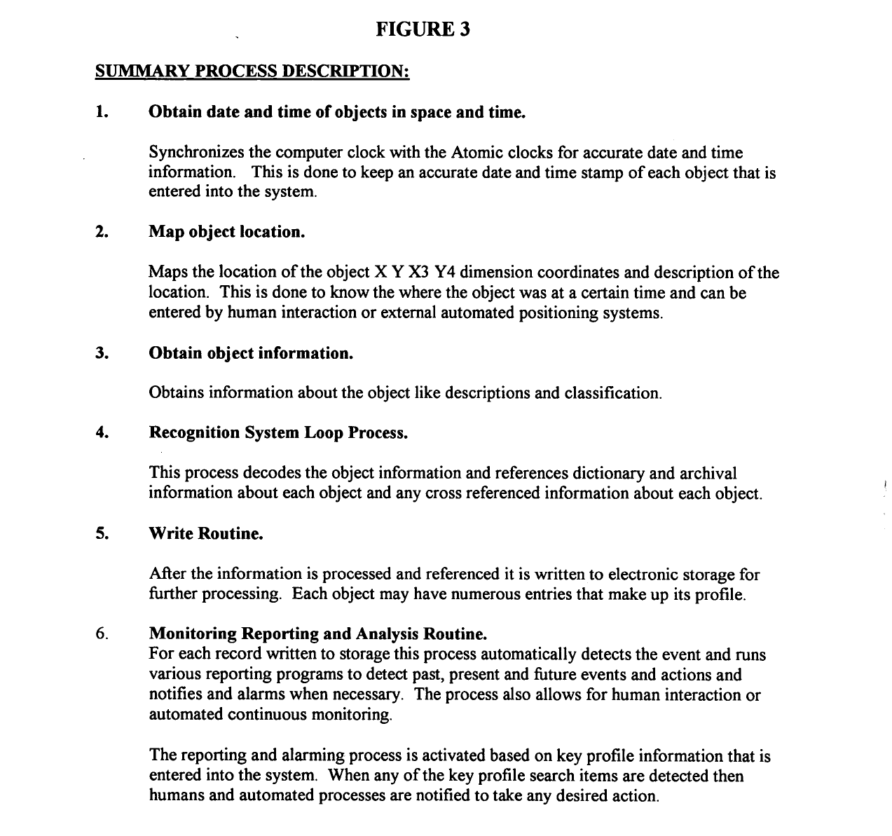

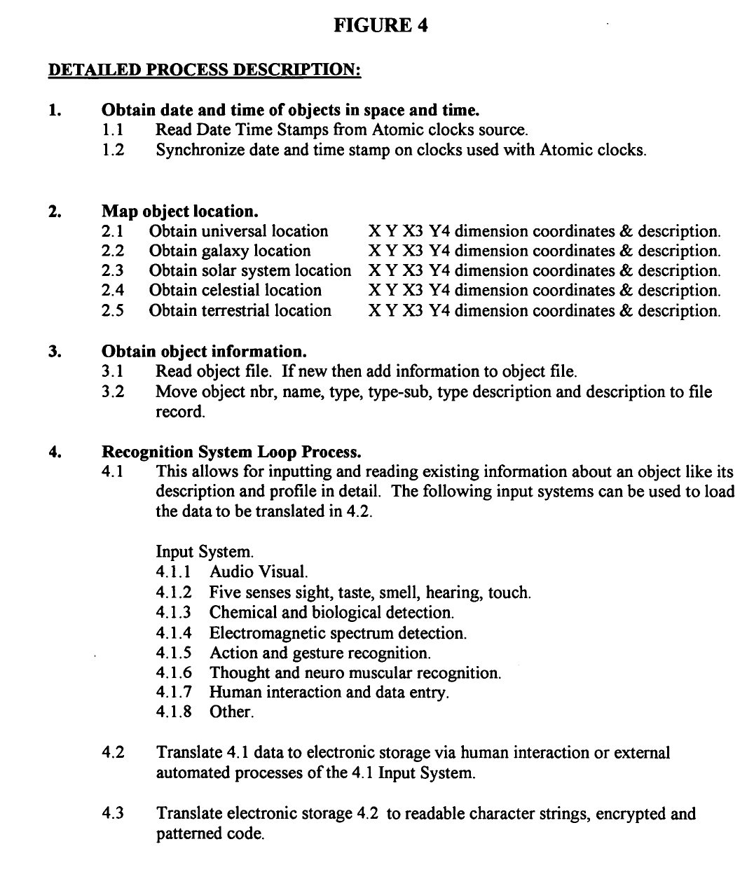

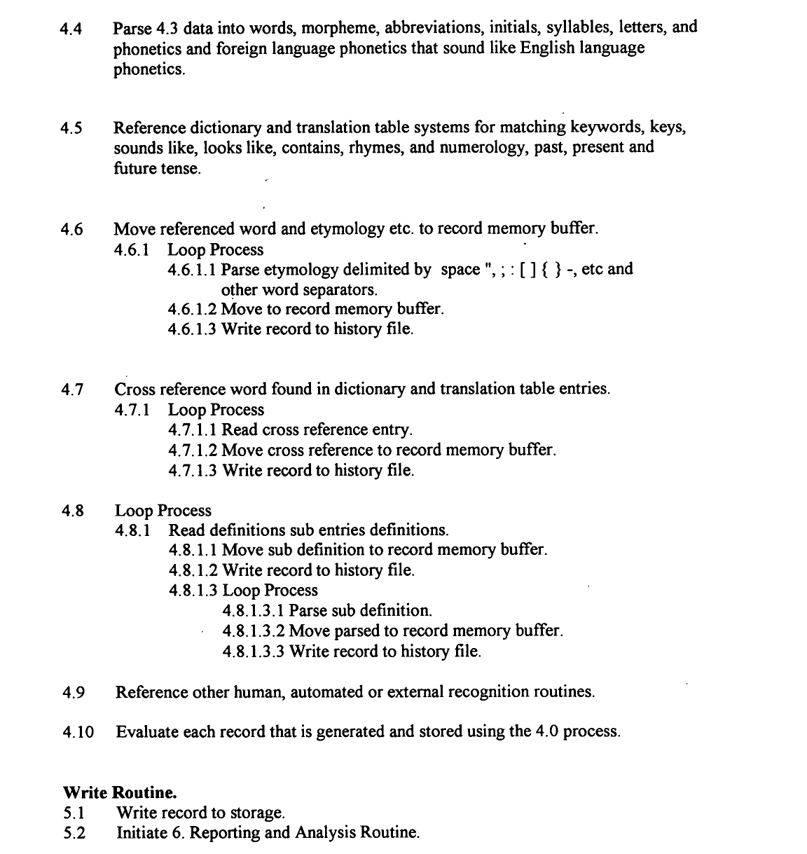

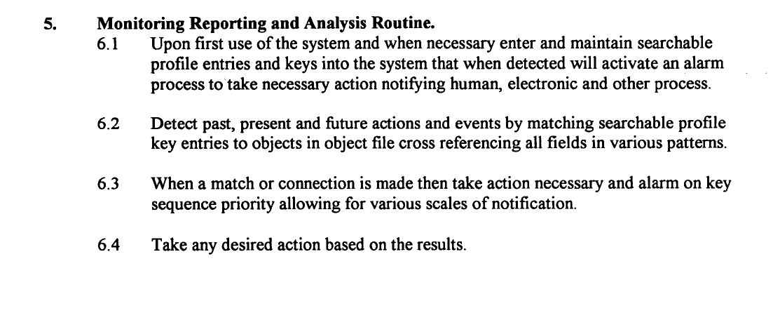

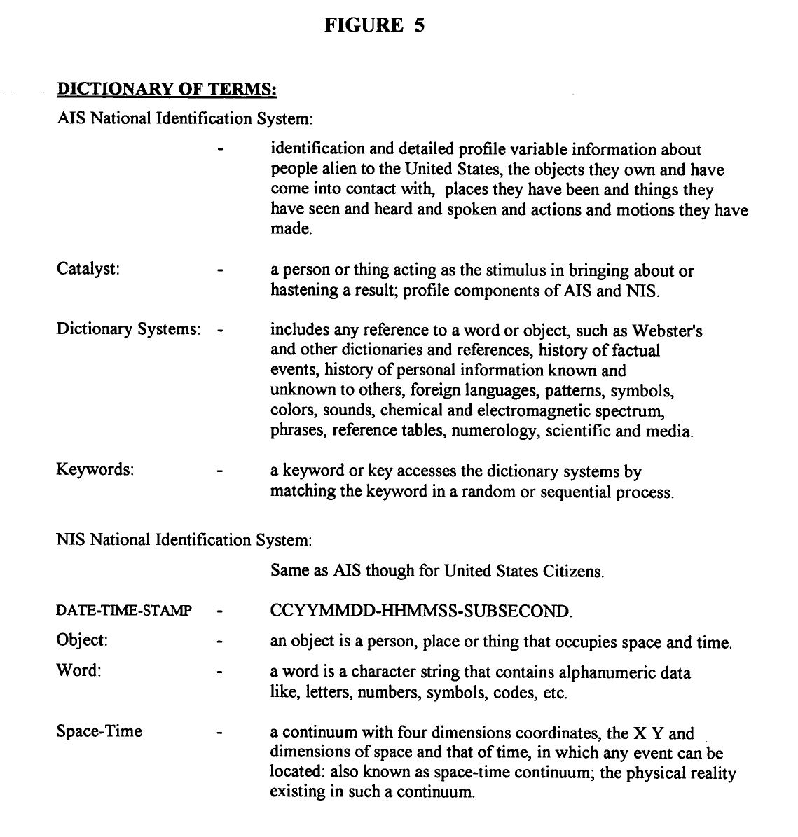

1. FIG. 1-4 Show the steps necessary to capture object information and decode the information into a file structure that can be referenced. First the date and time clocks used are synchronized with the most accurate date and time available which are atomic clocks. The devices used to provide the date and time from then on could be a wrist watch or clocks on input devices like cameras. Second the location of the object in space time is then obtained. Then the object information is obtained. If the object information is already on file then it is used in building the new file entry with the date time and object location. If it is not on file then the information is added via human or automated input. When the date and time, object location and object information description information is stored then the process of FIG. 4 processes. The process of FIG. 4 sub processes 4.1 through 4.9 continue until there are numerous entries written to the file system. For one object mapped in space and time there can be numerous records stored with each detailed cross reference and sub classifications and decoded definitions.

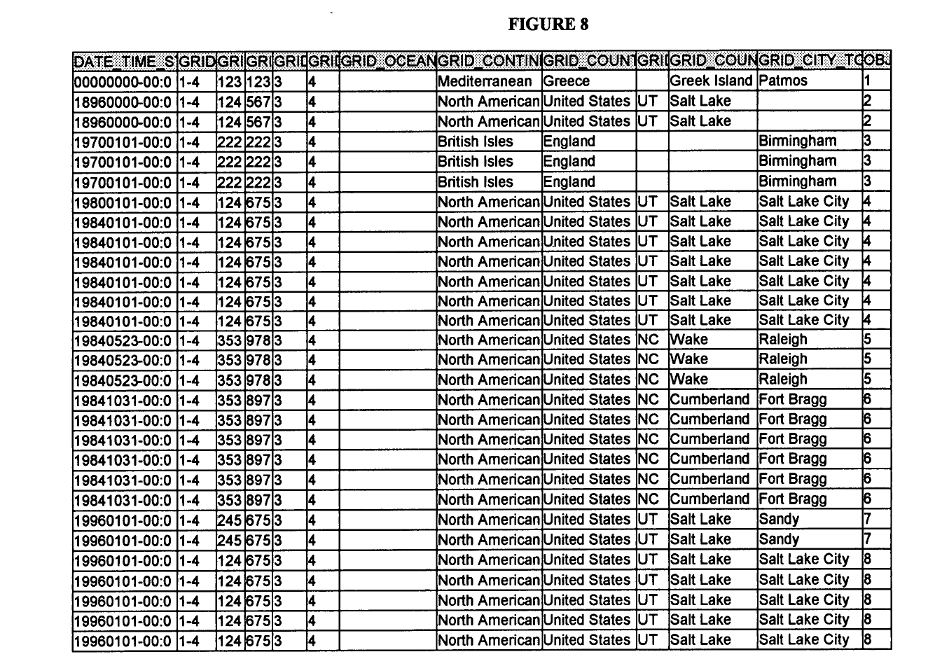

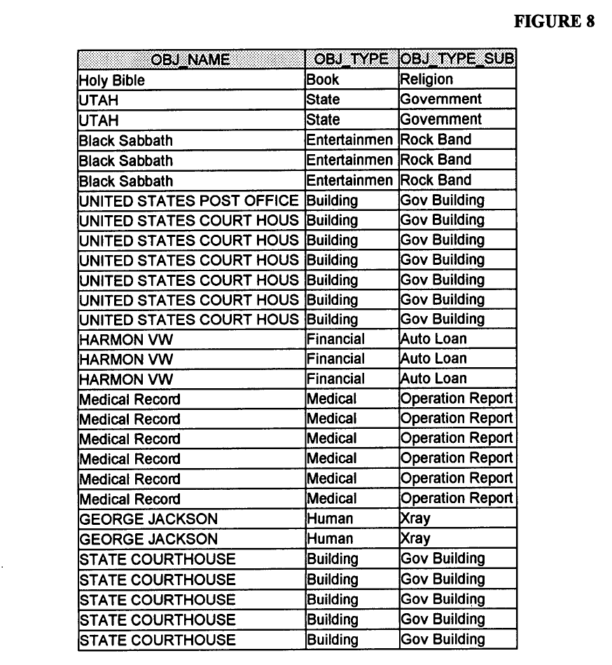

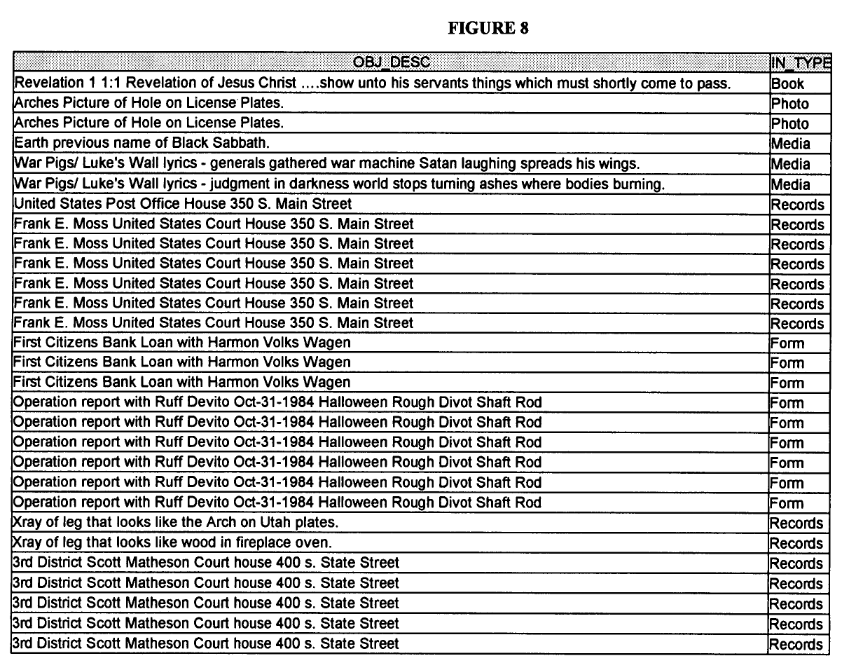

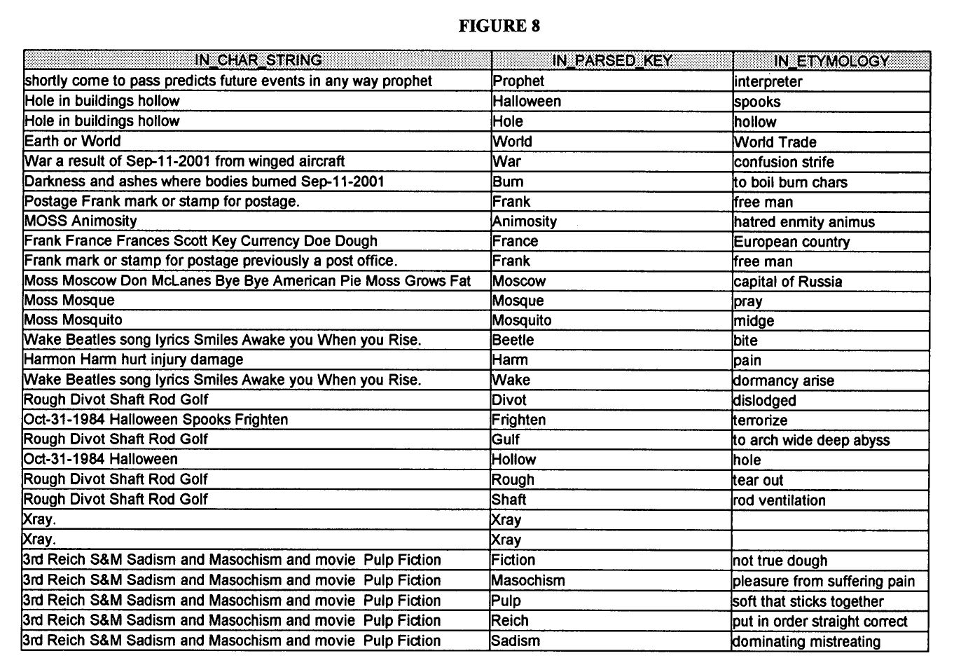

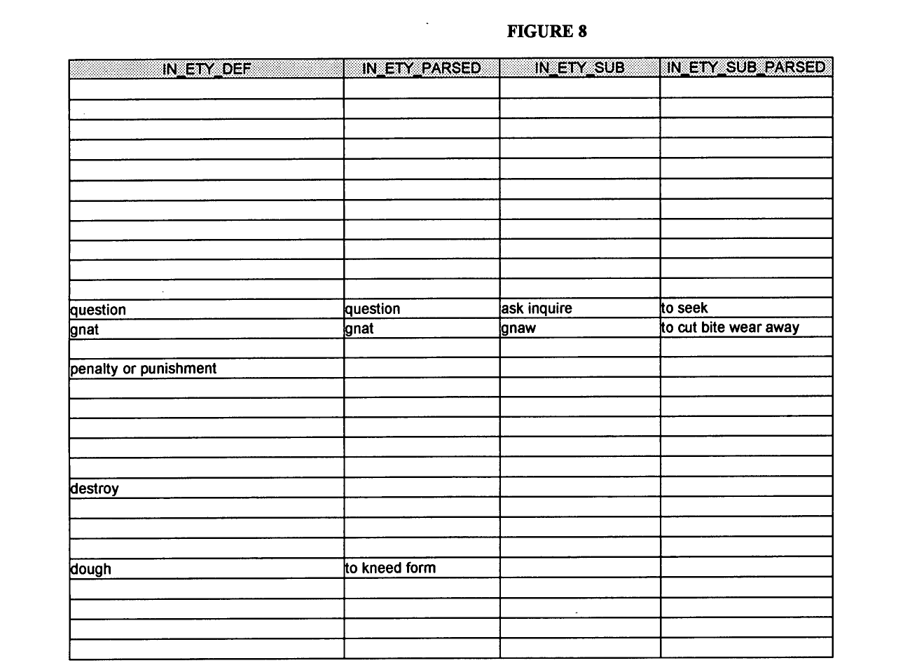

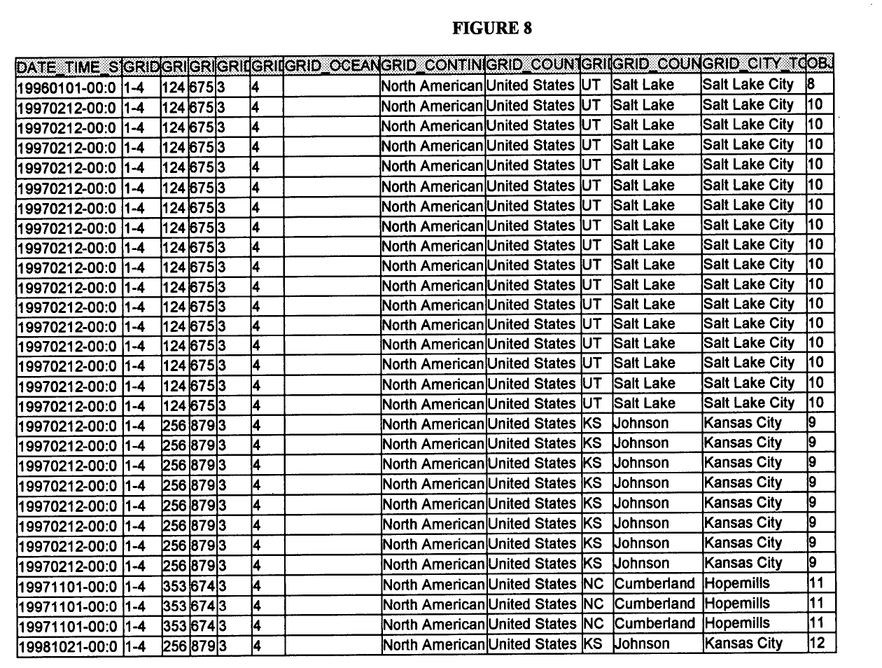

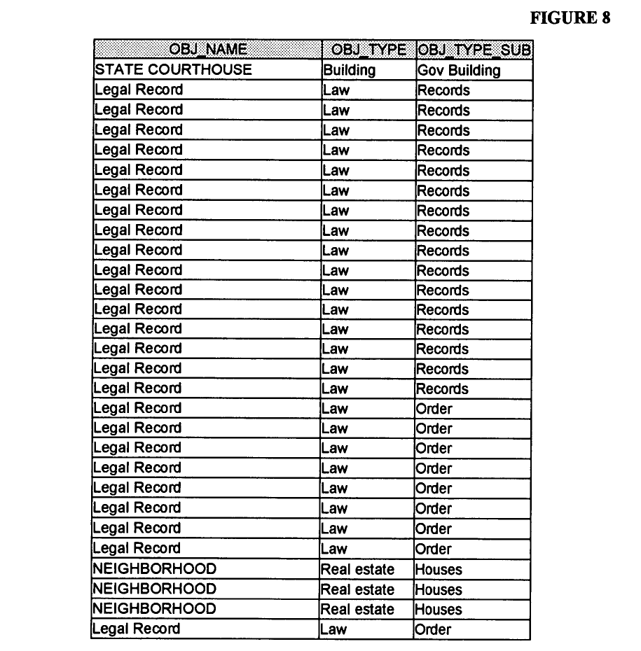

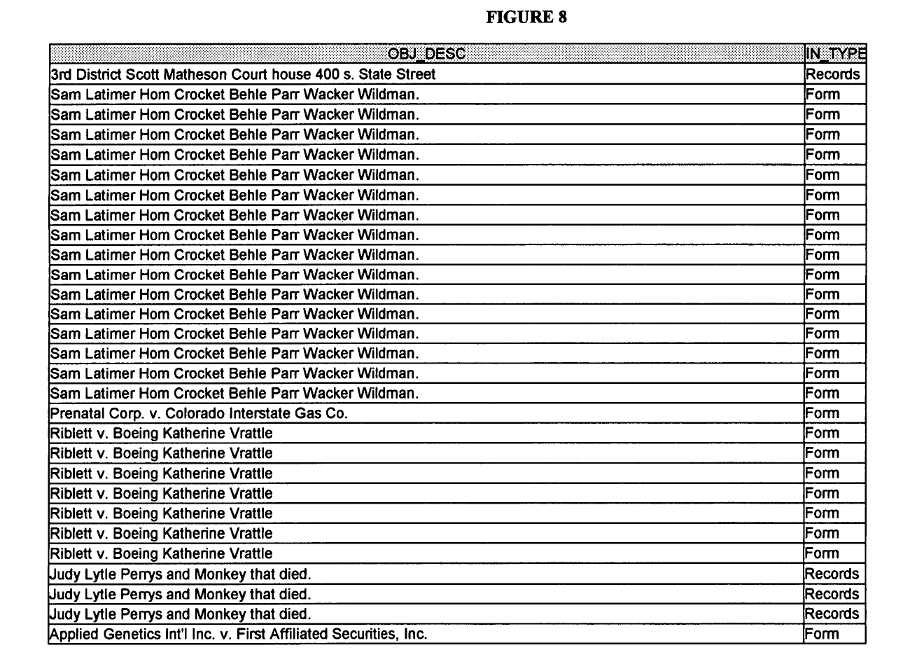

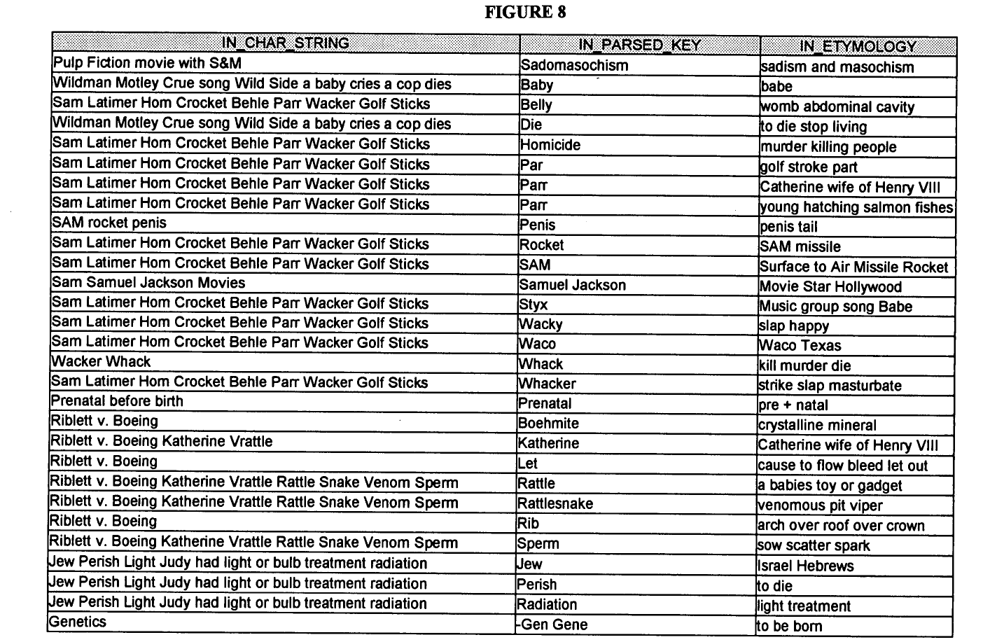

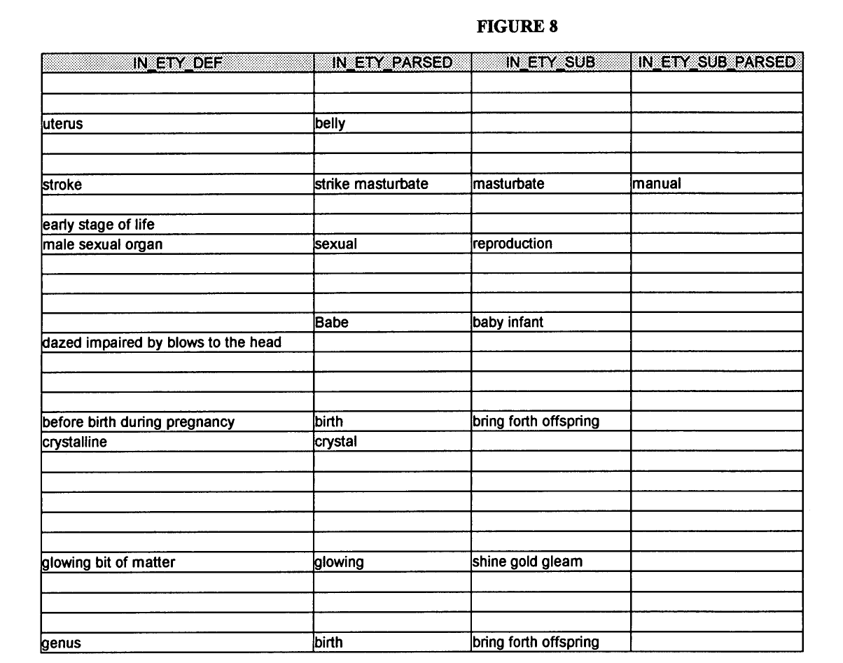

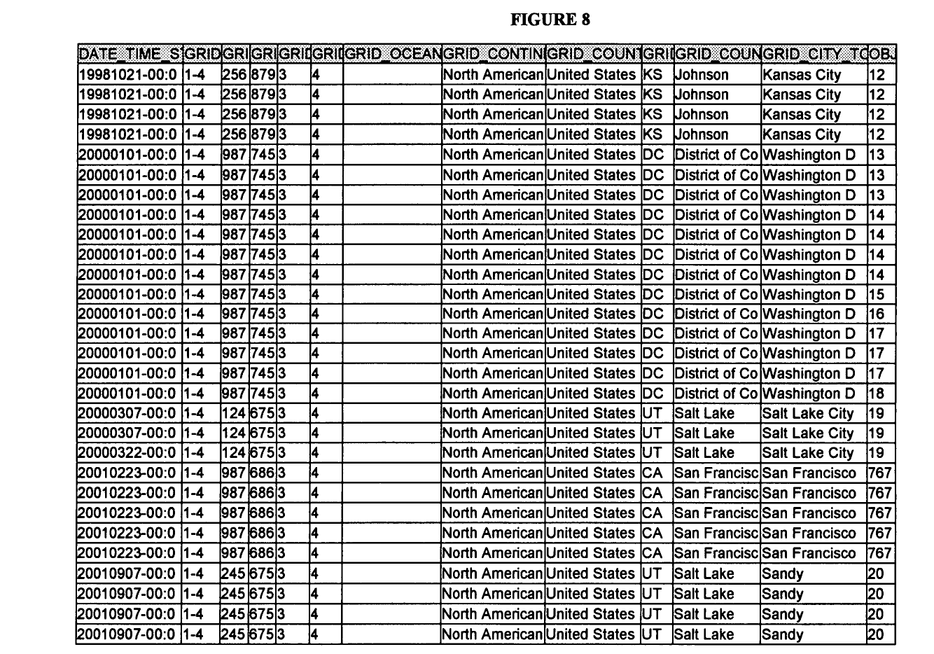

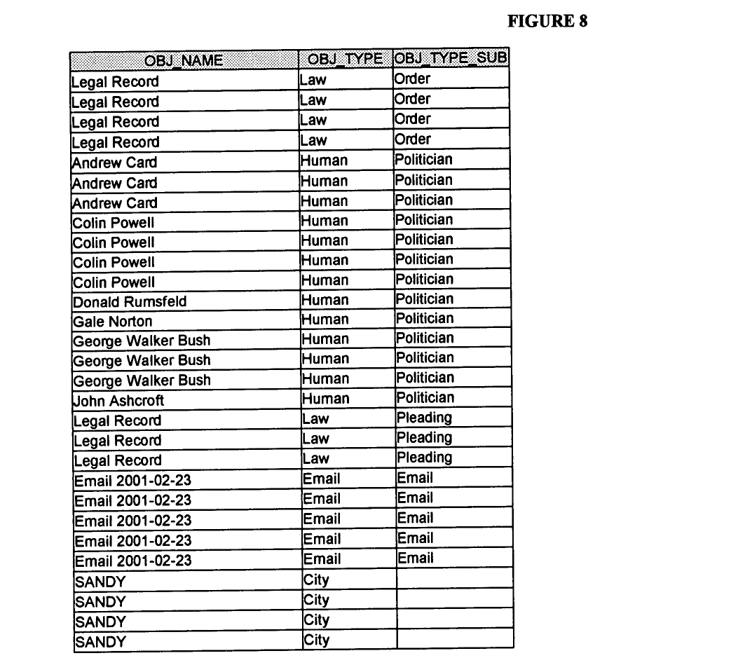

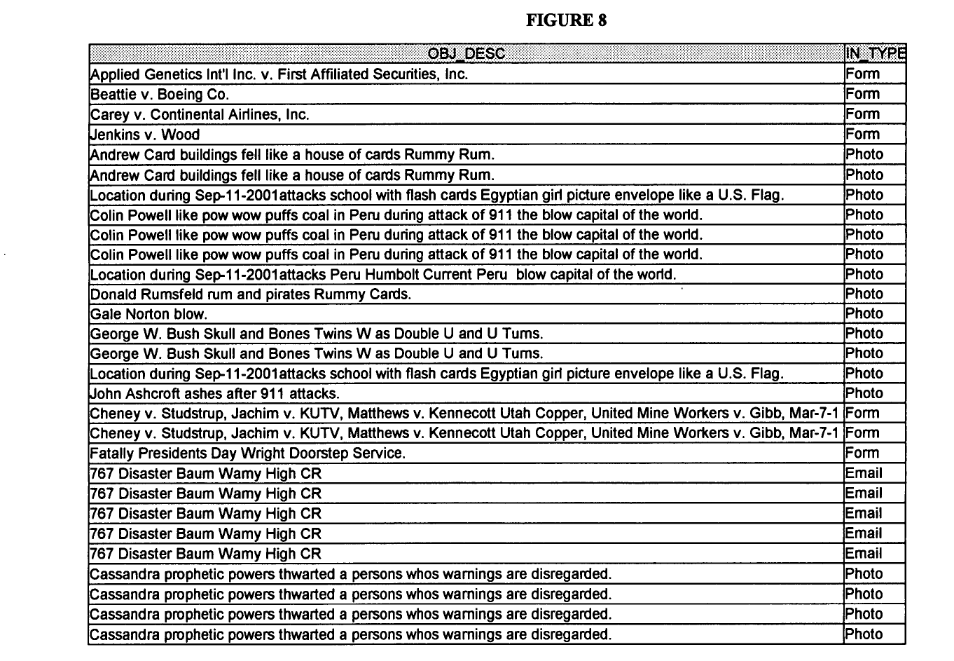

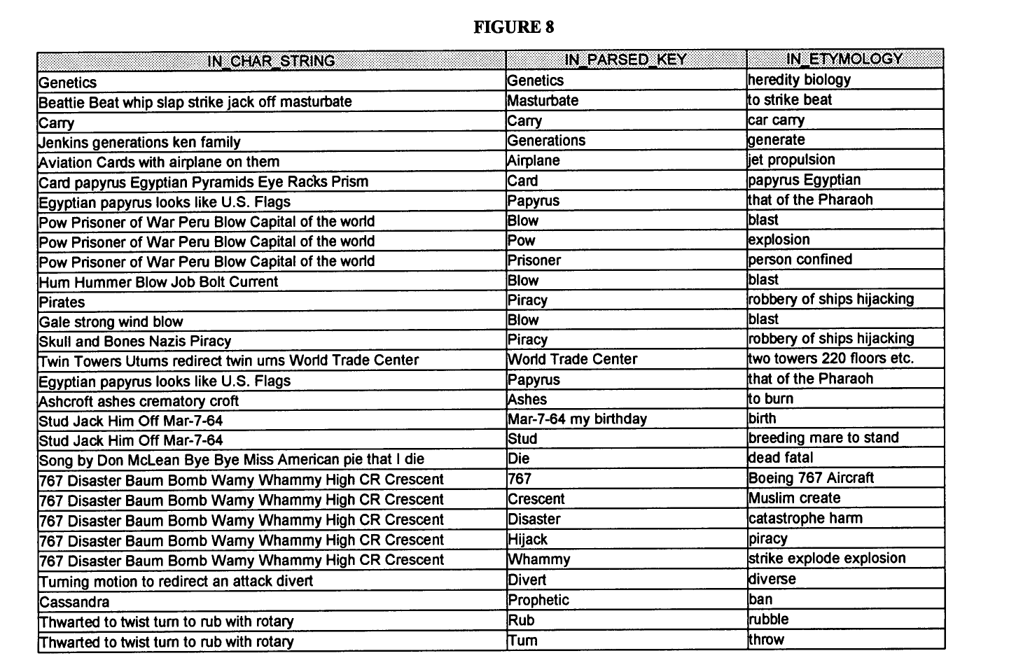

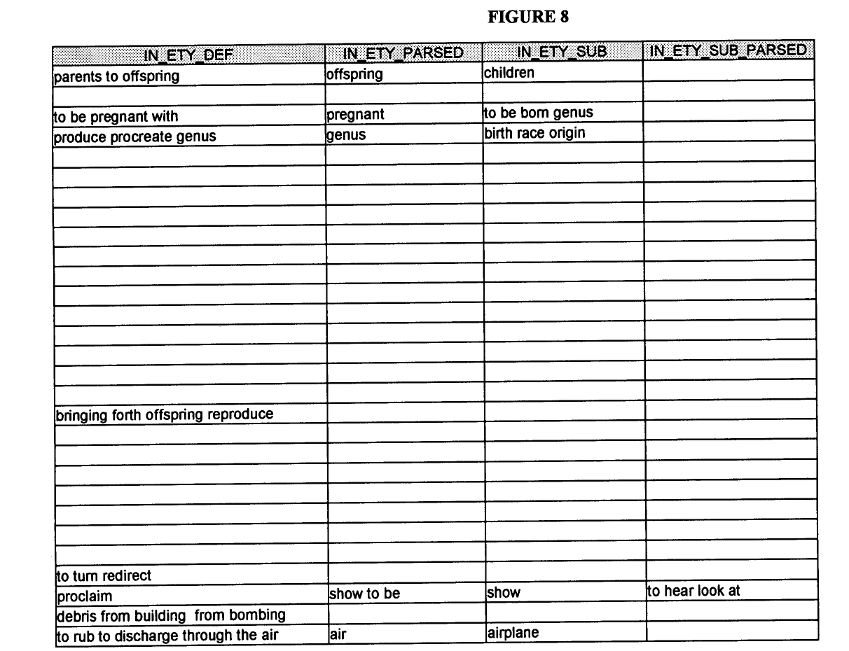

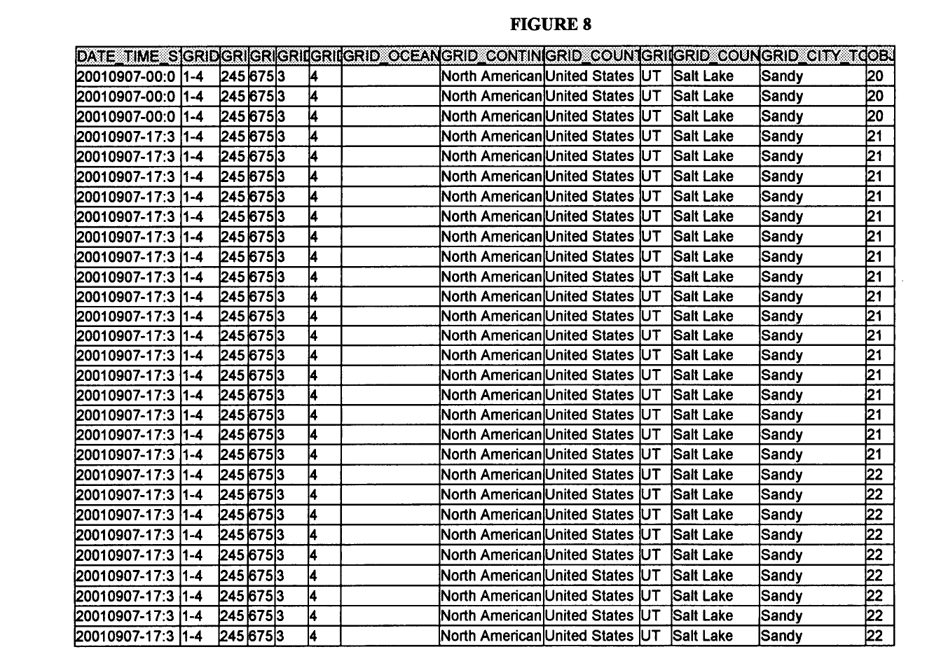

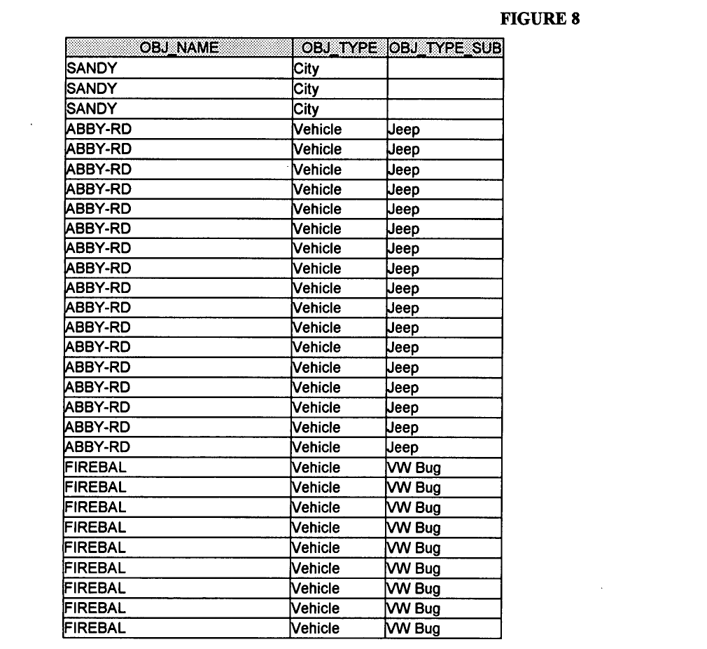

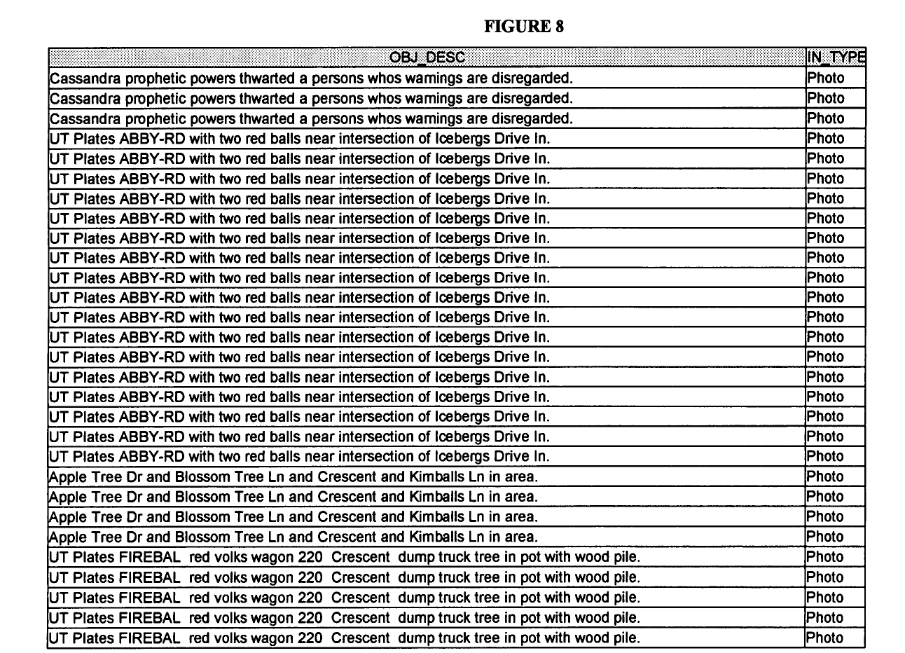

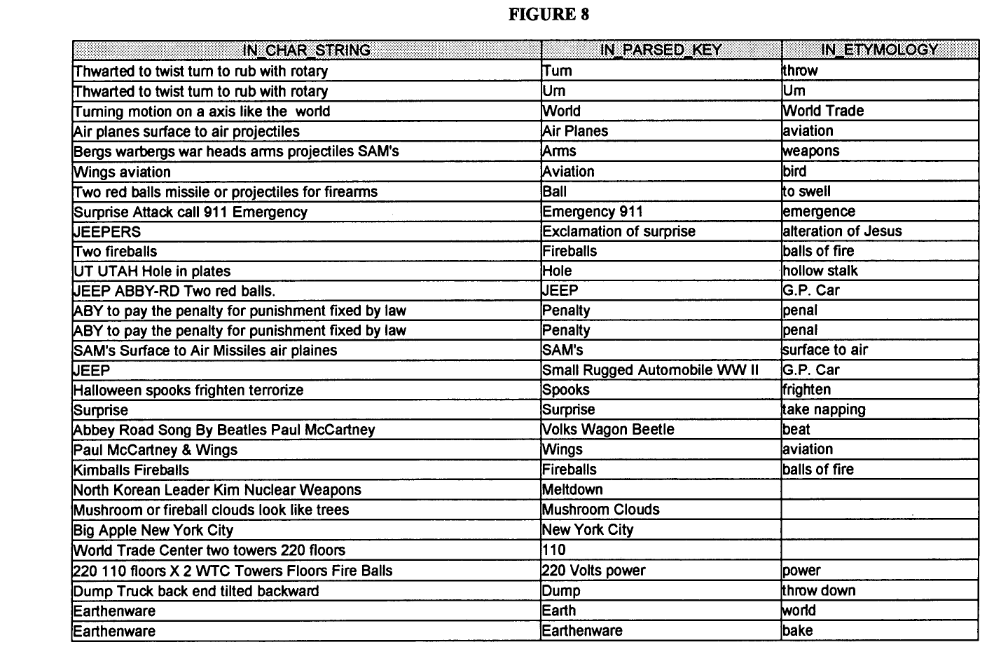

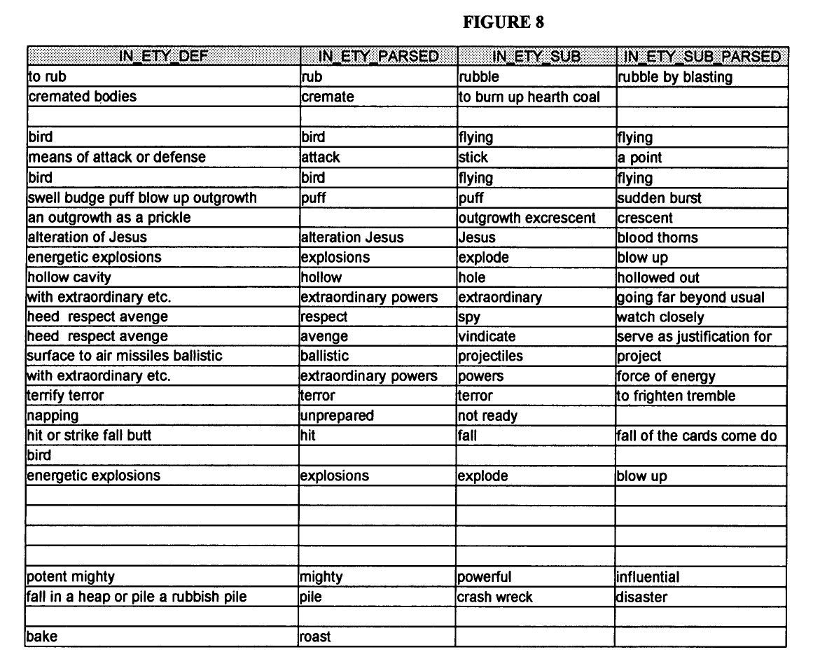

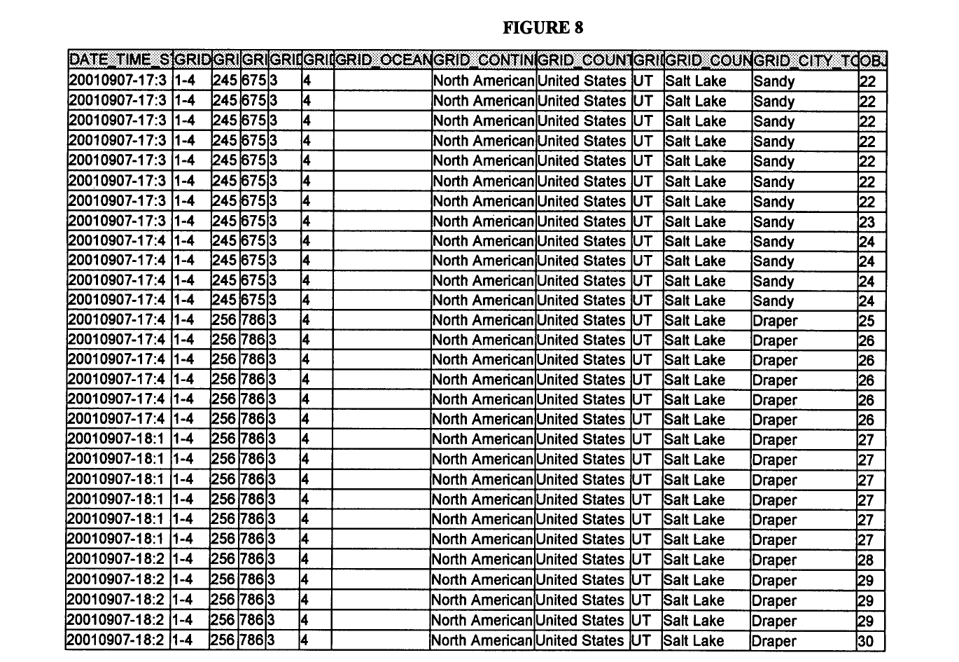

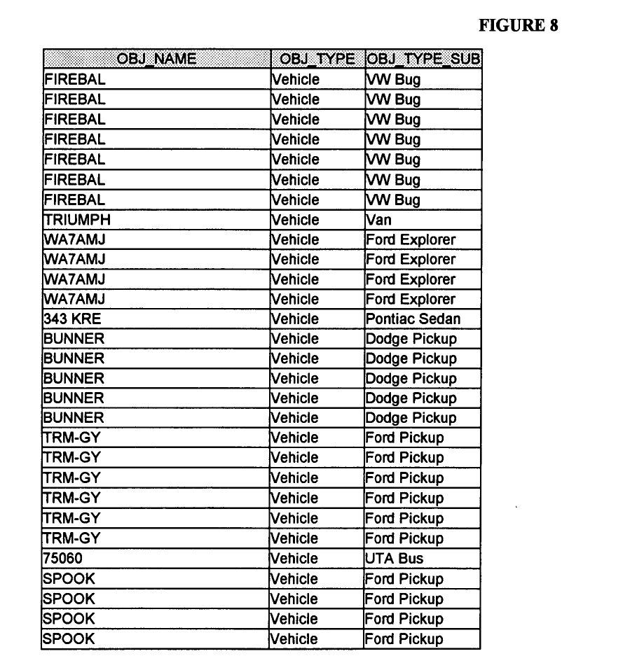

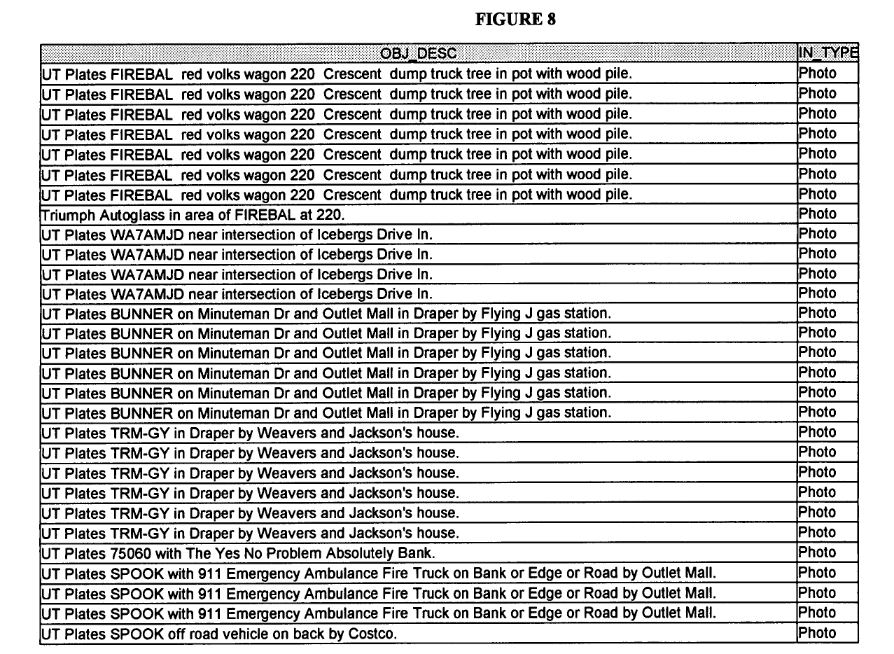

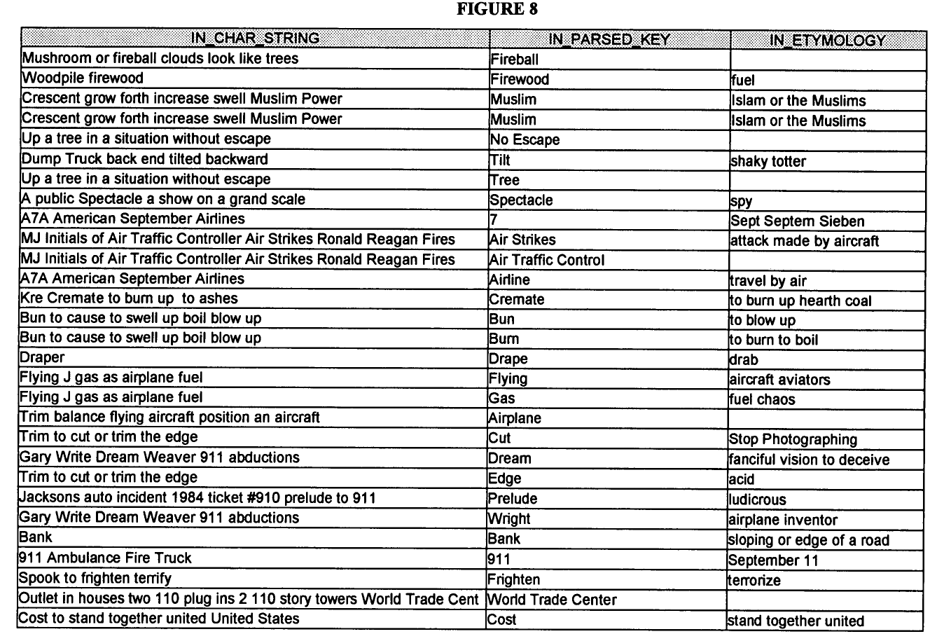

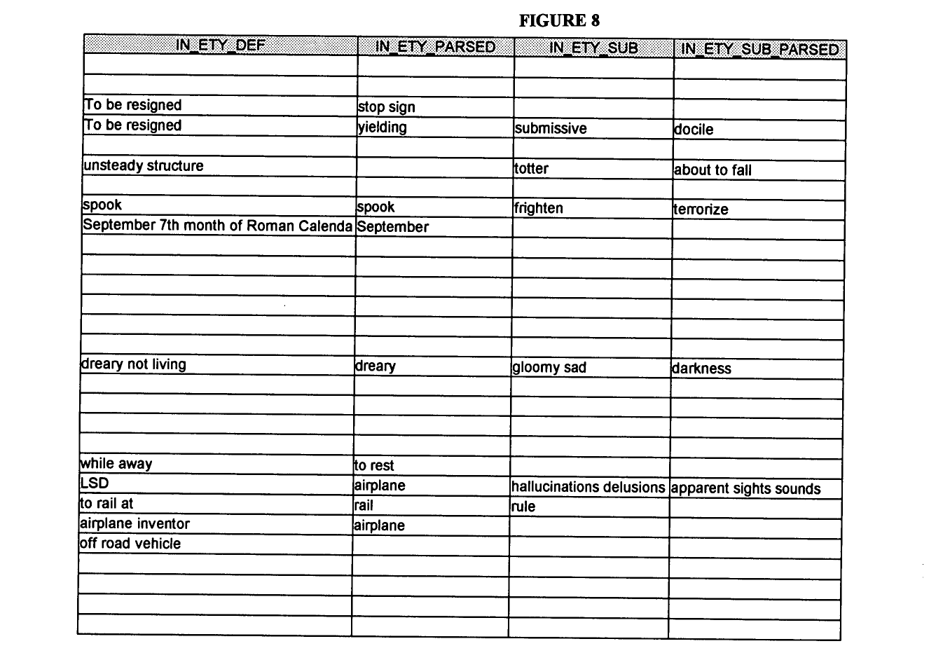

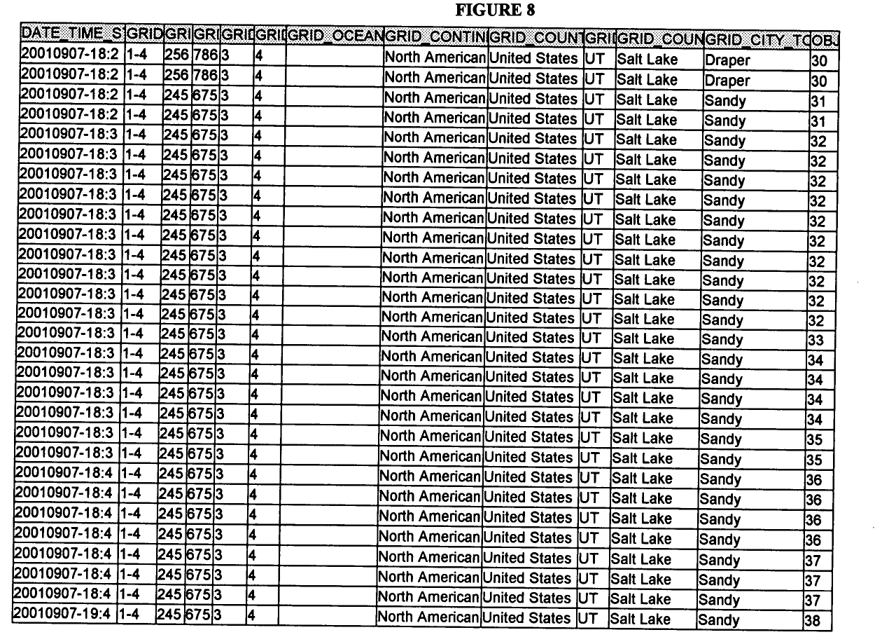

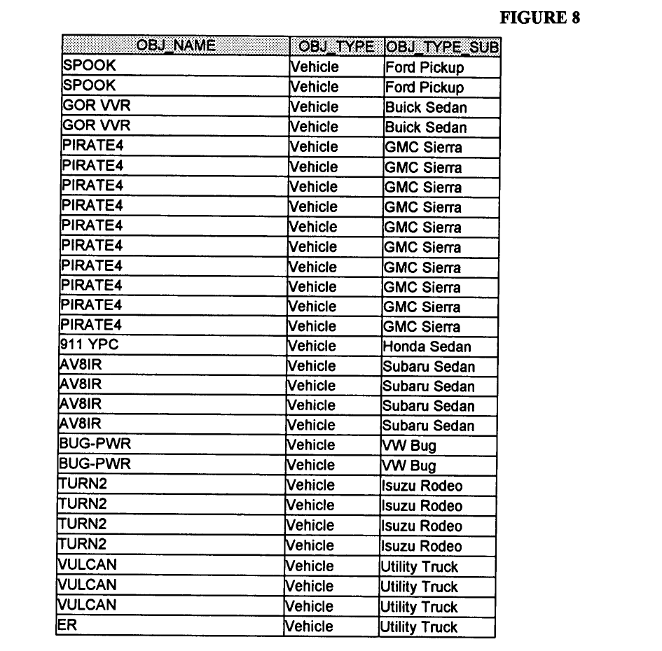

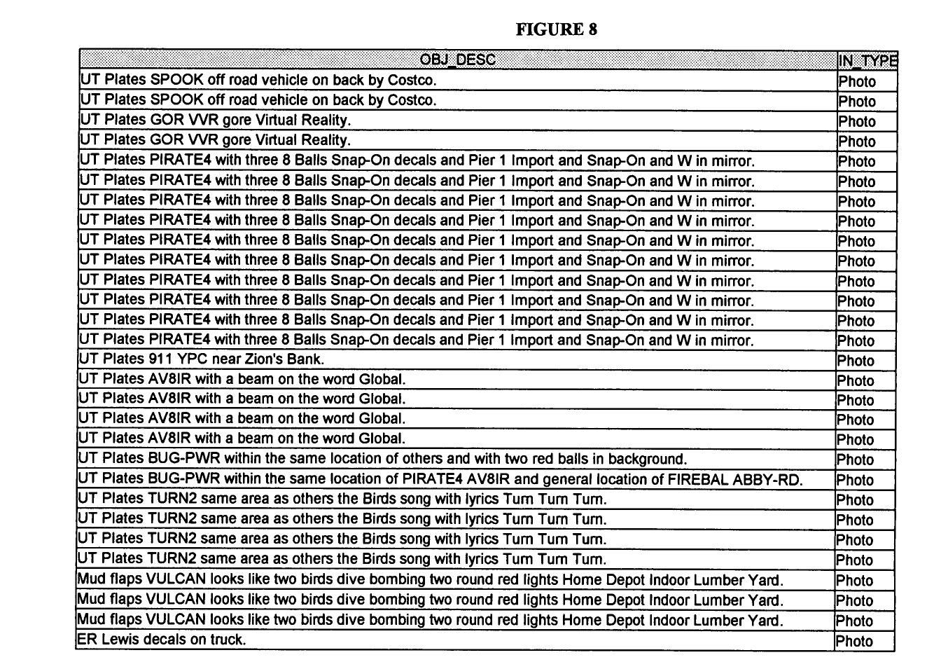

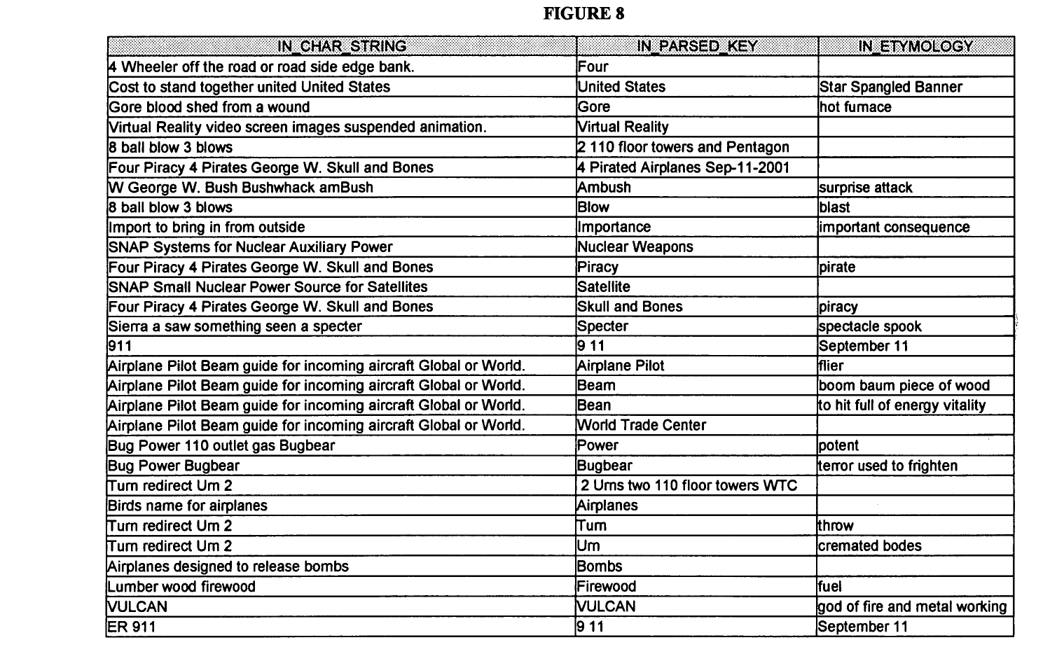

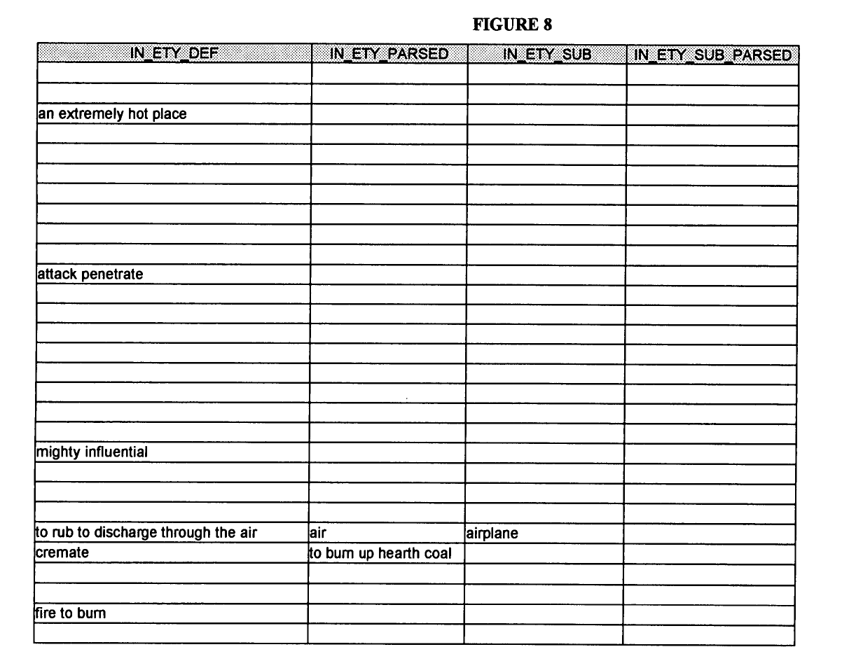

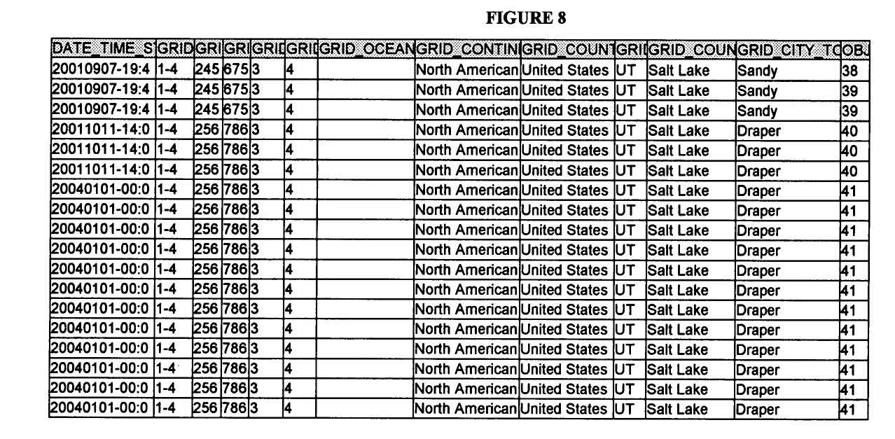

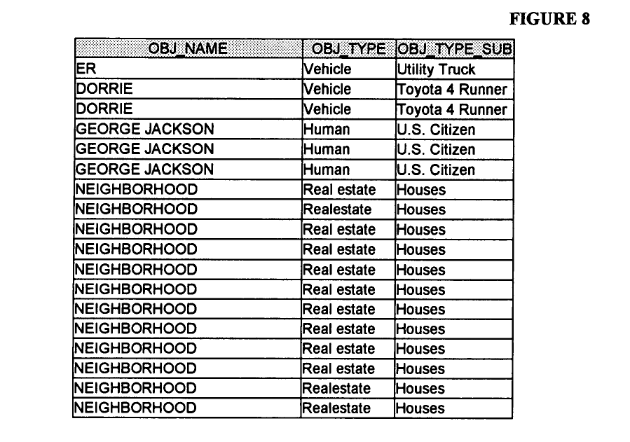

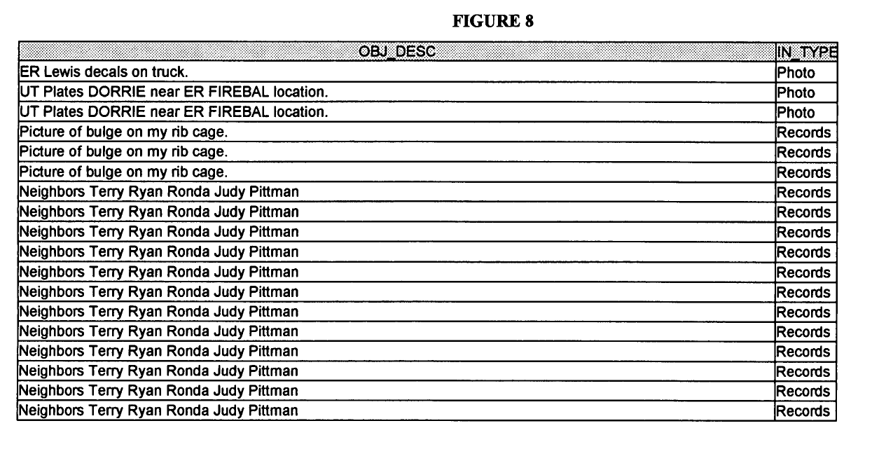

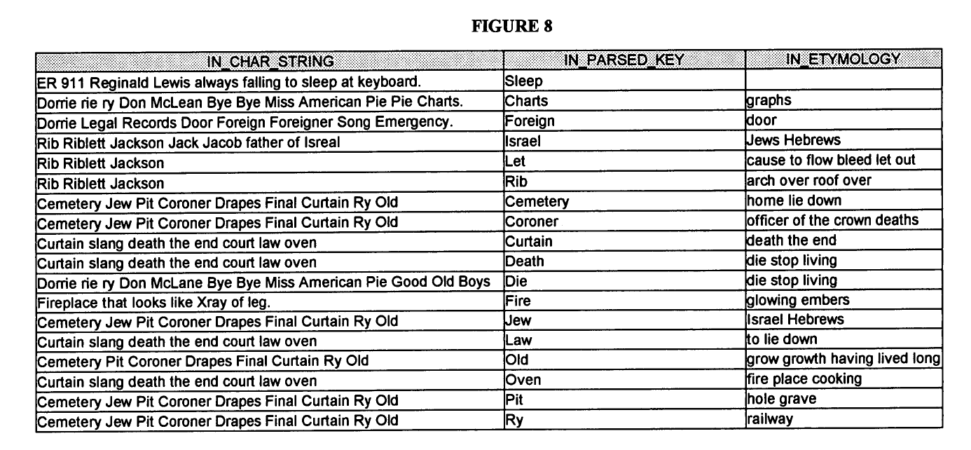

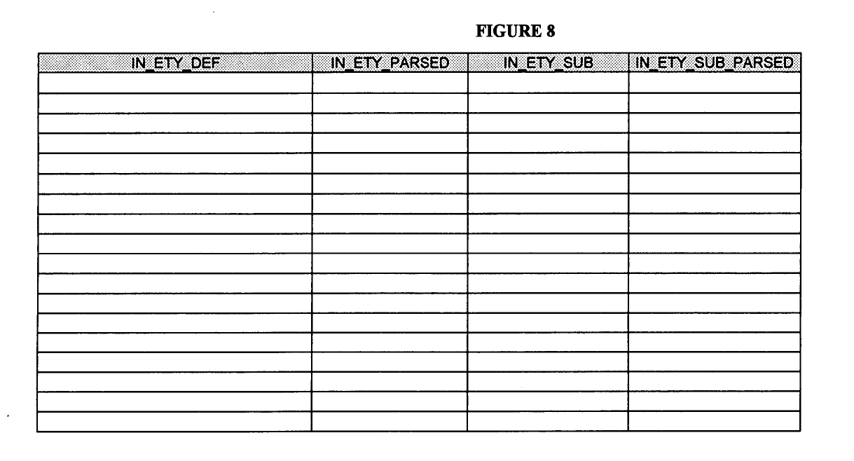

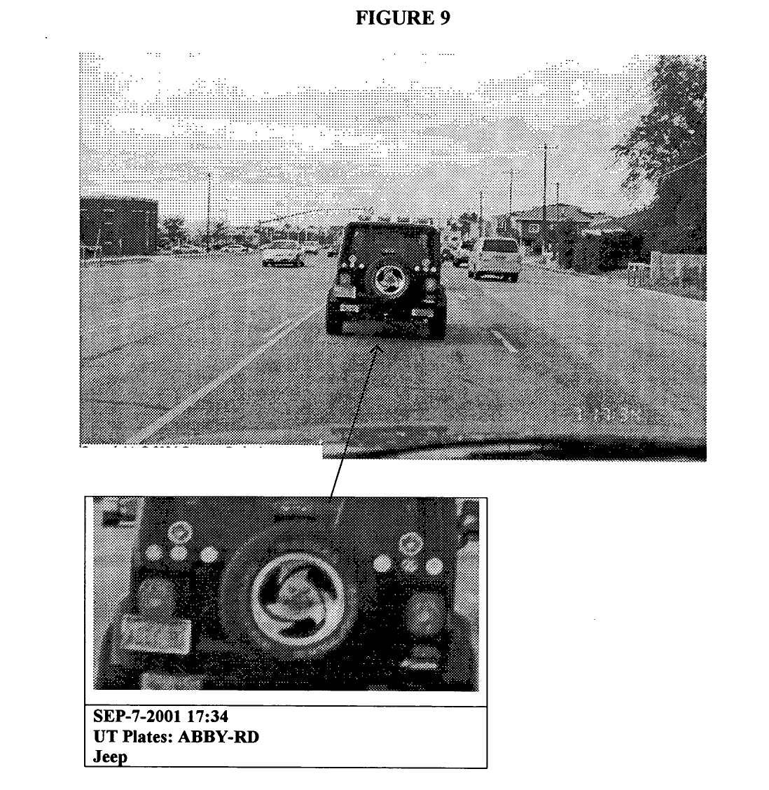

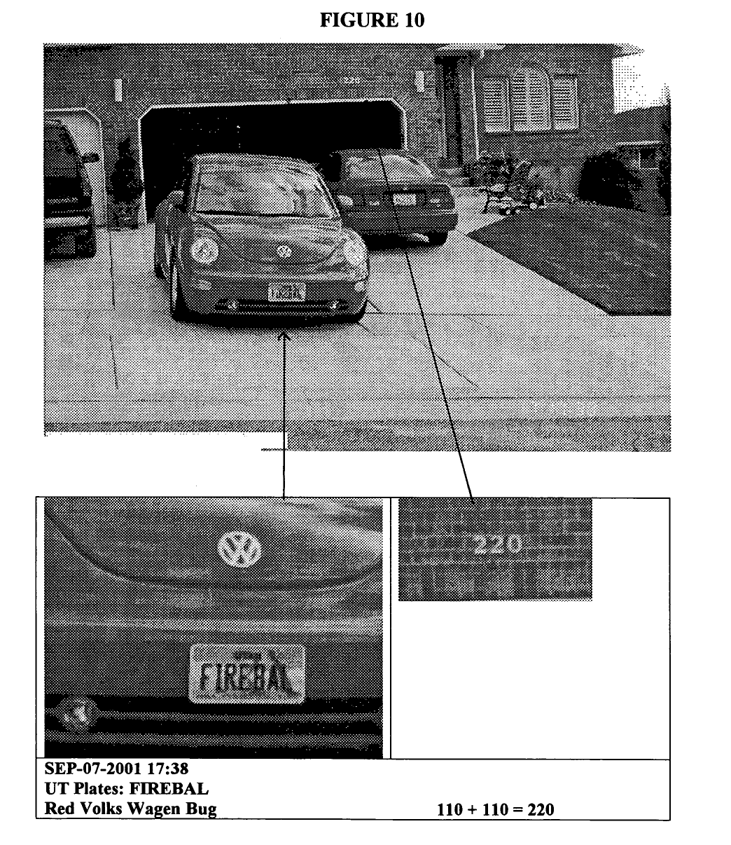

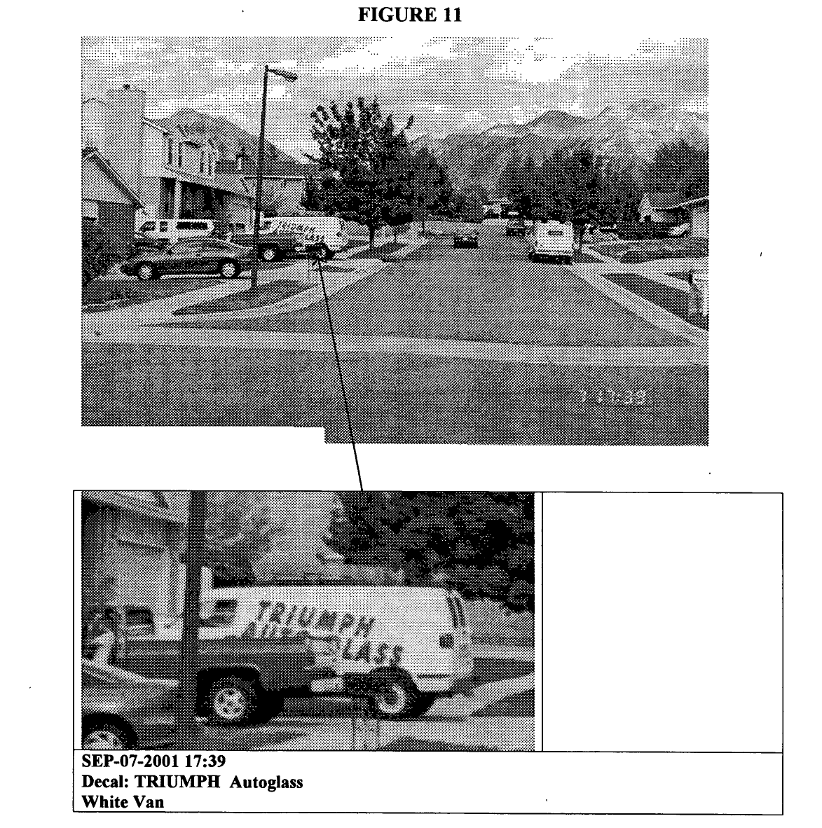

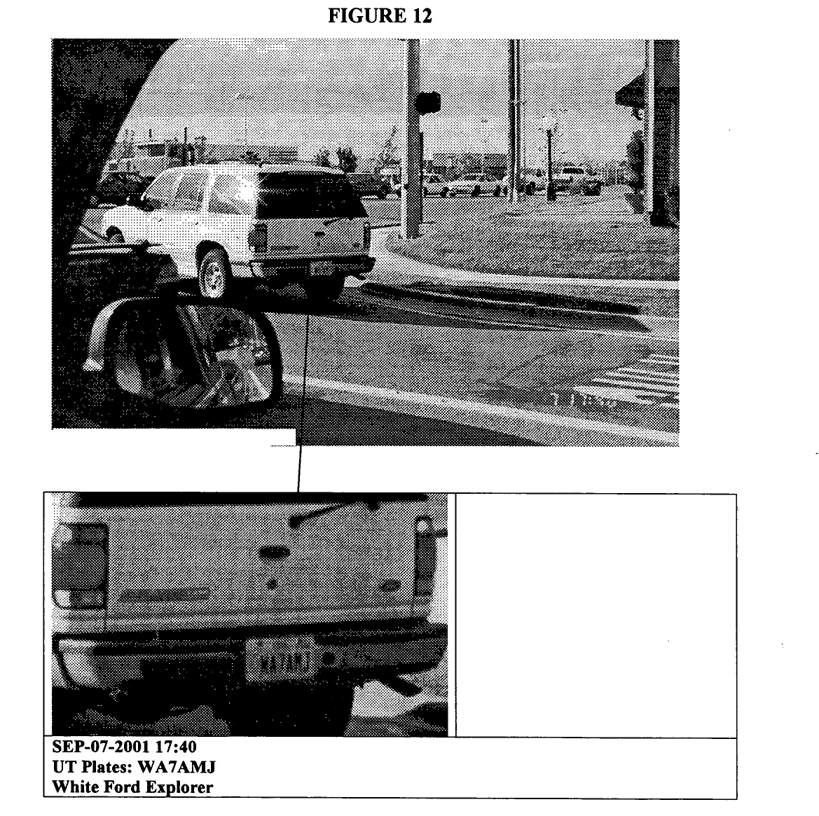

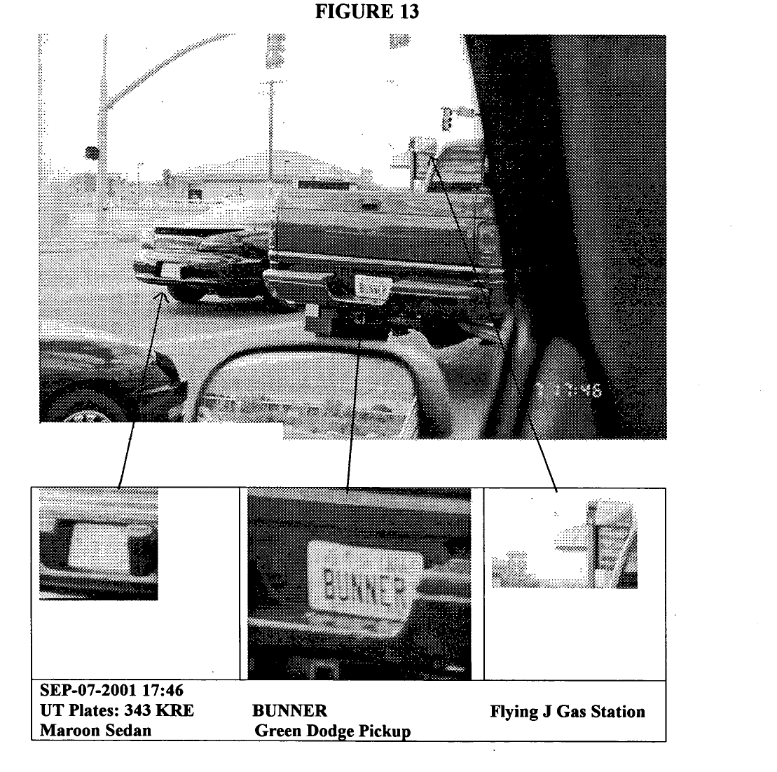

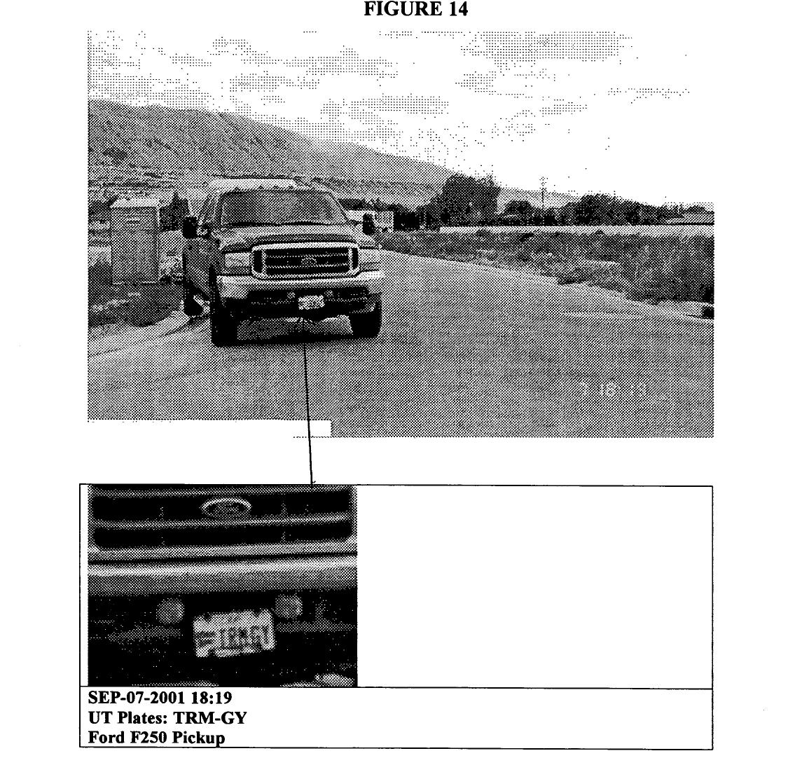

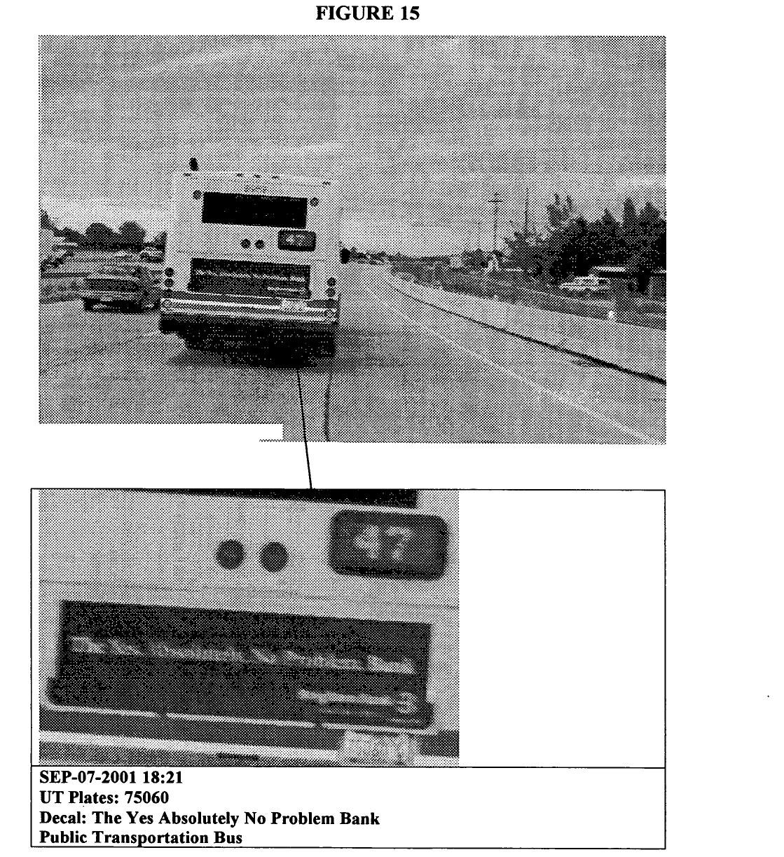

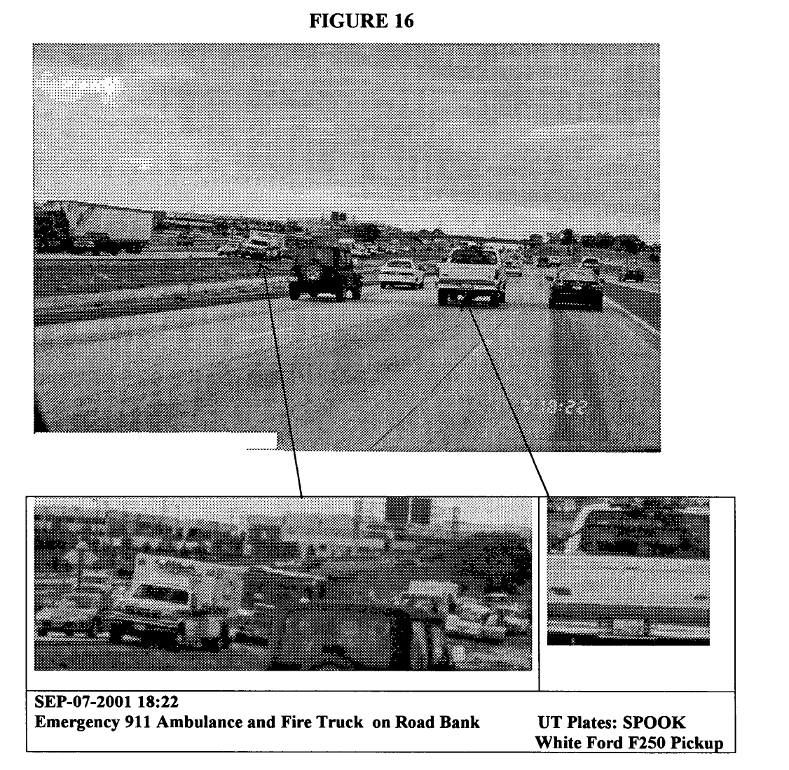

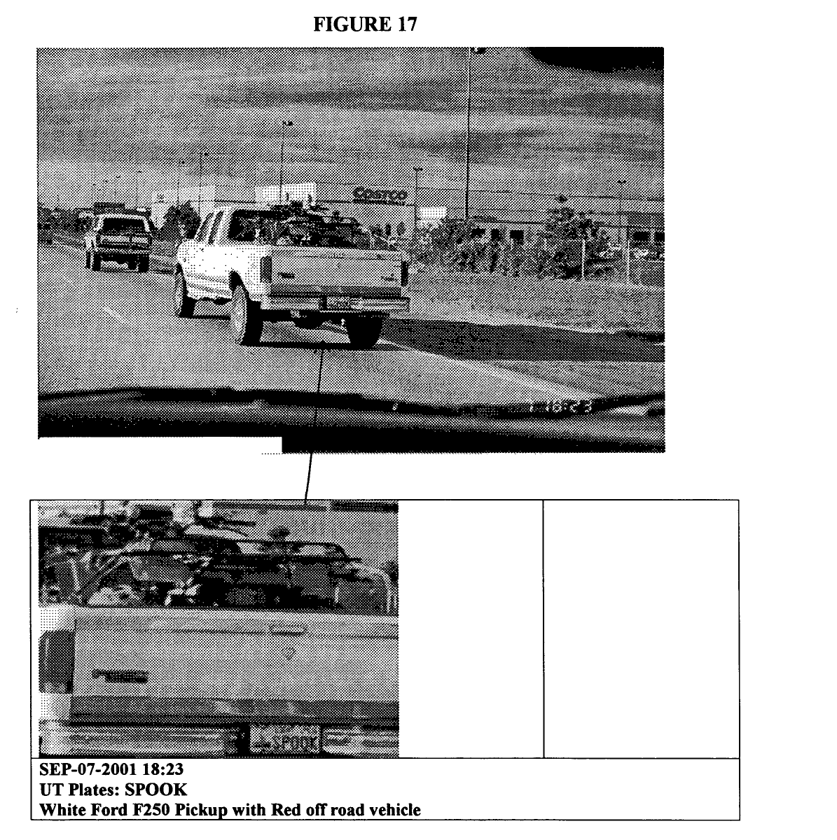

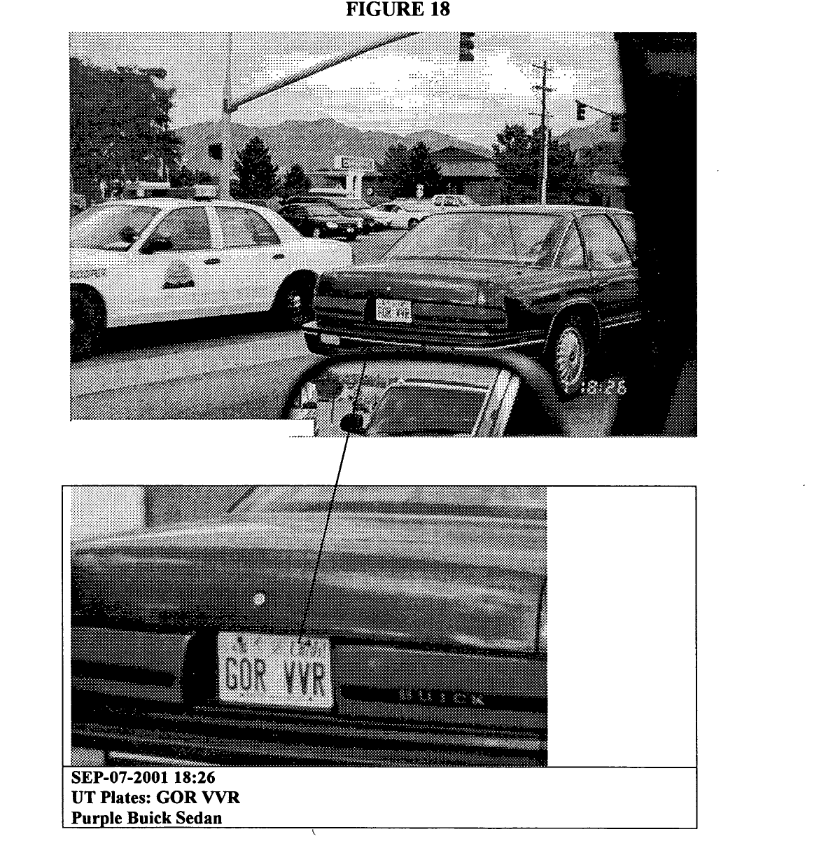

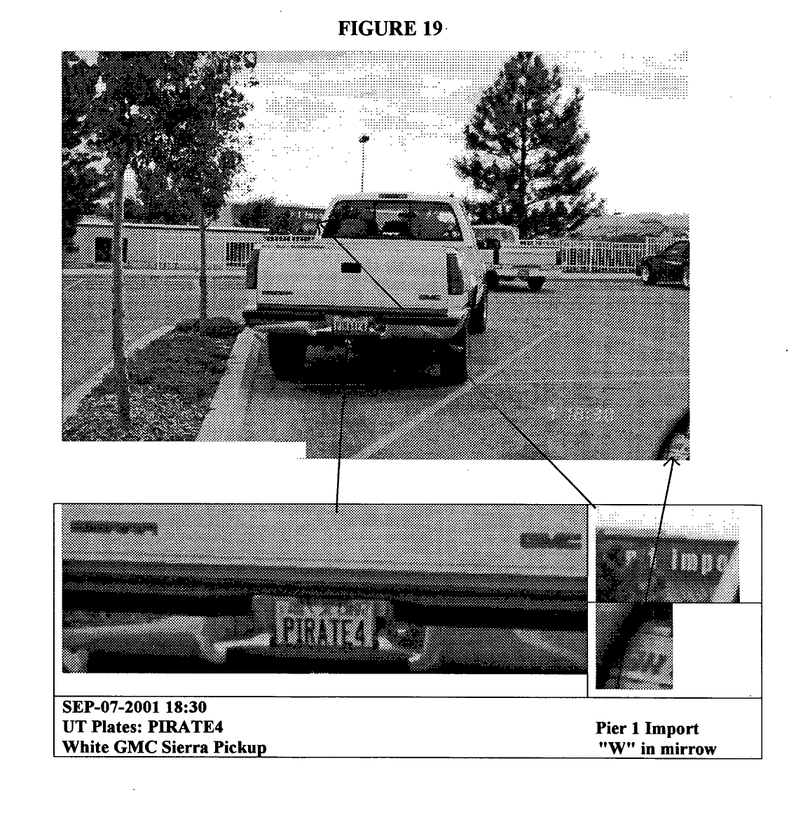

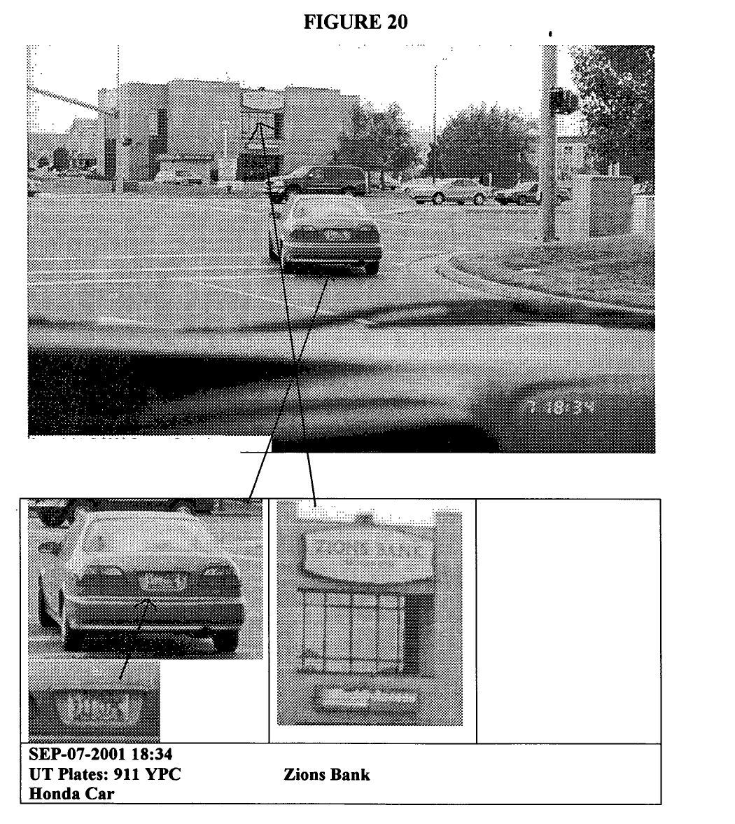

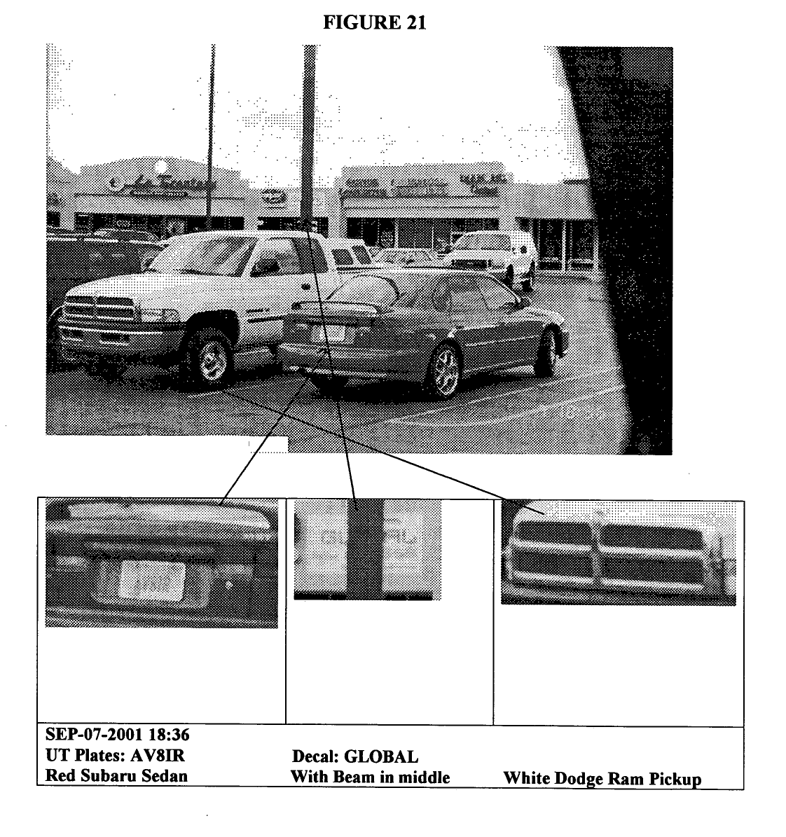

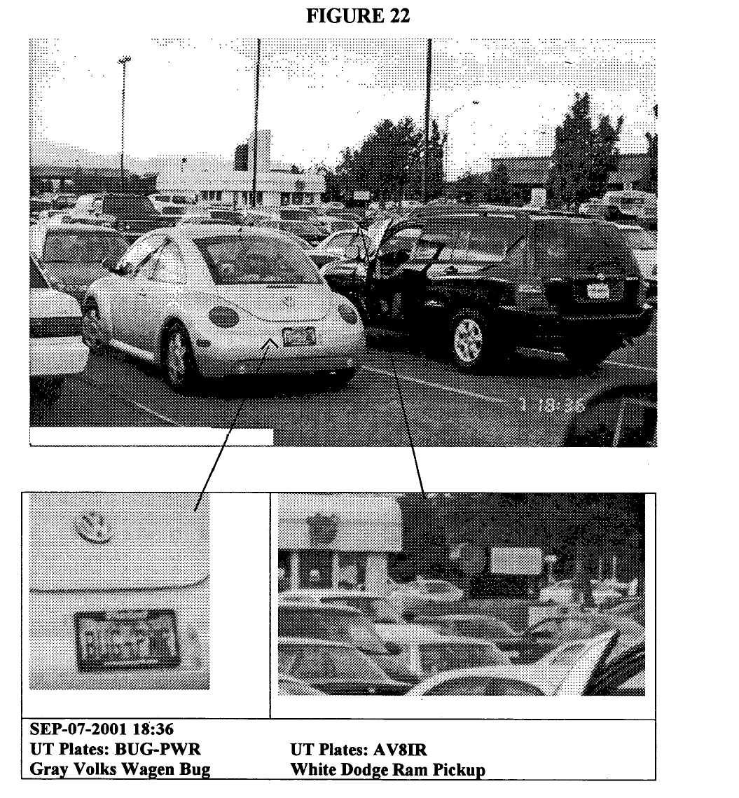

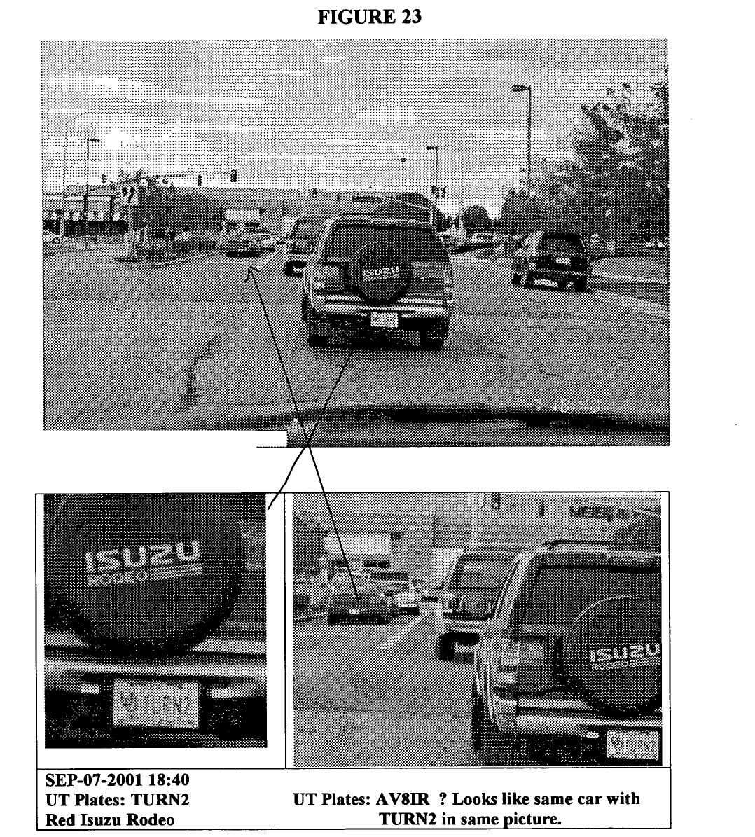

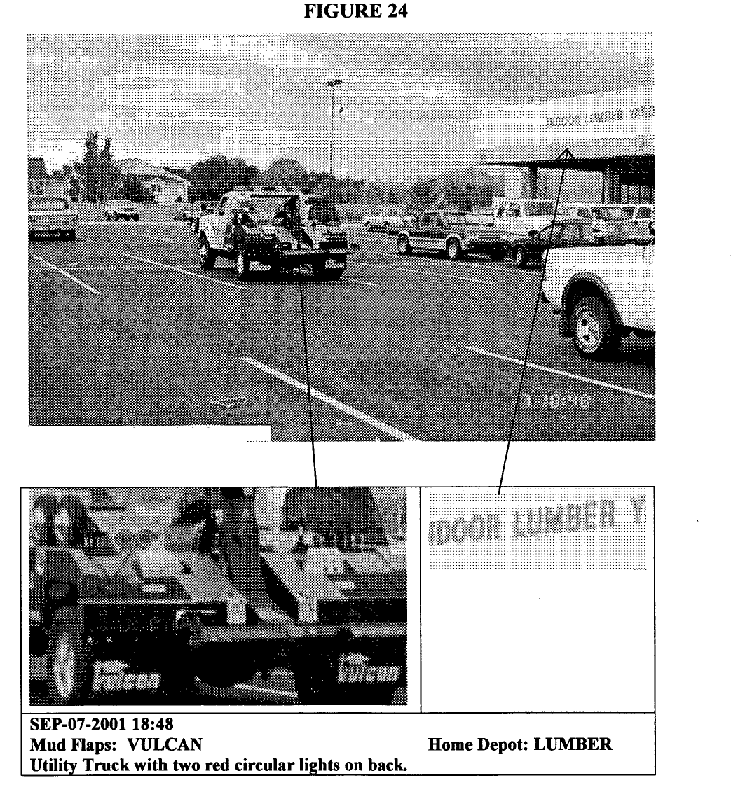

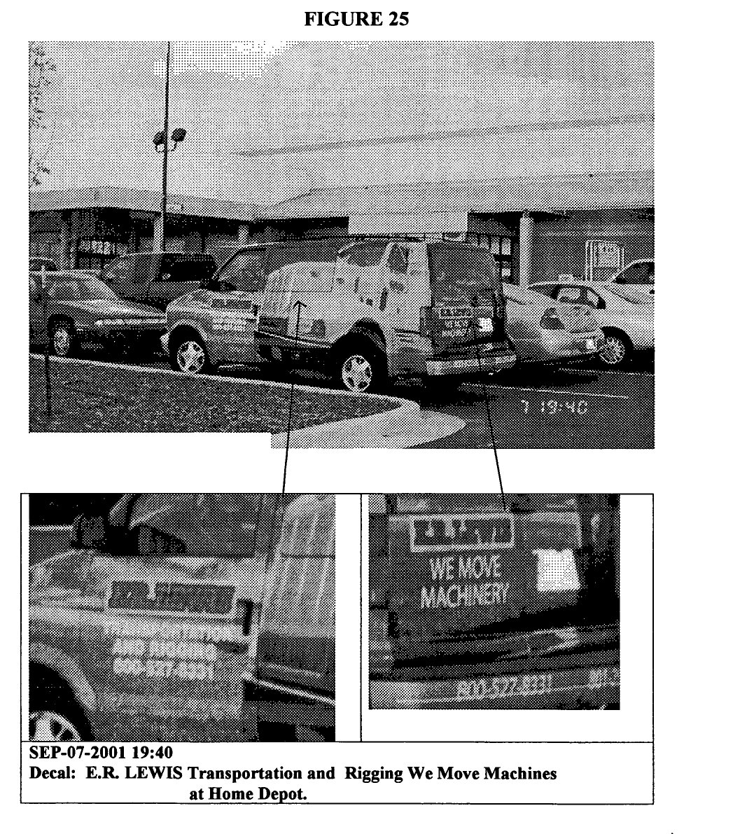

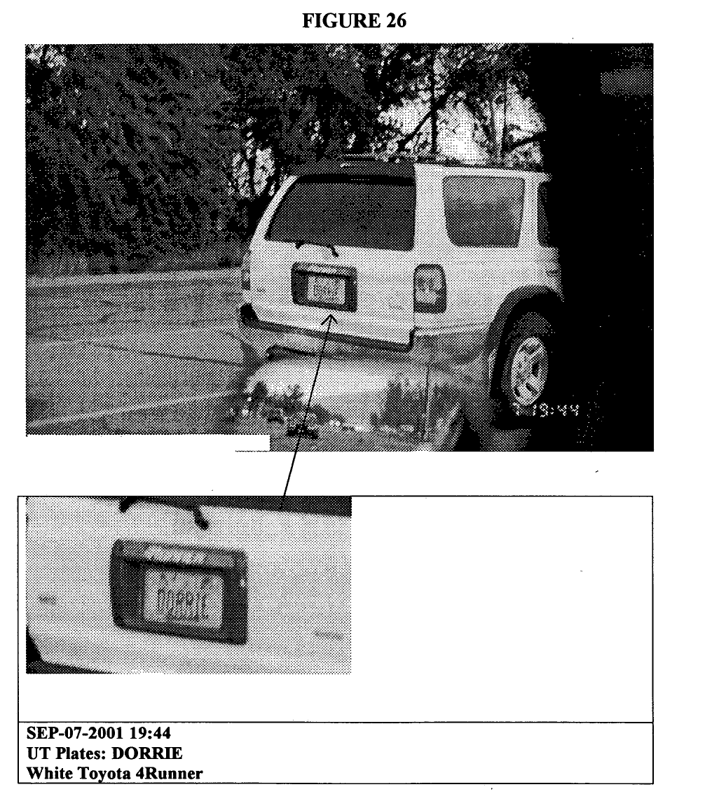

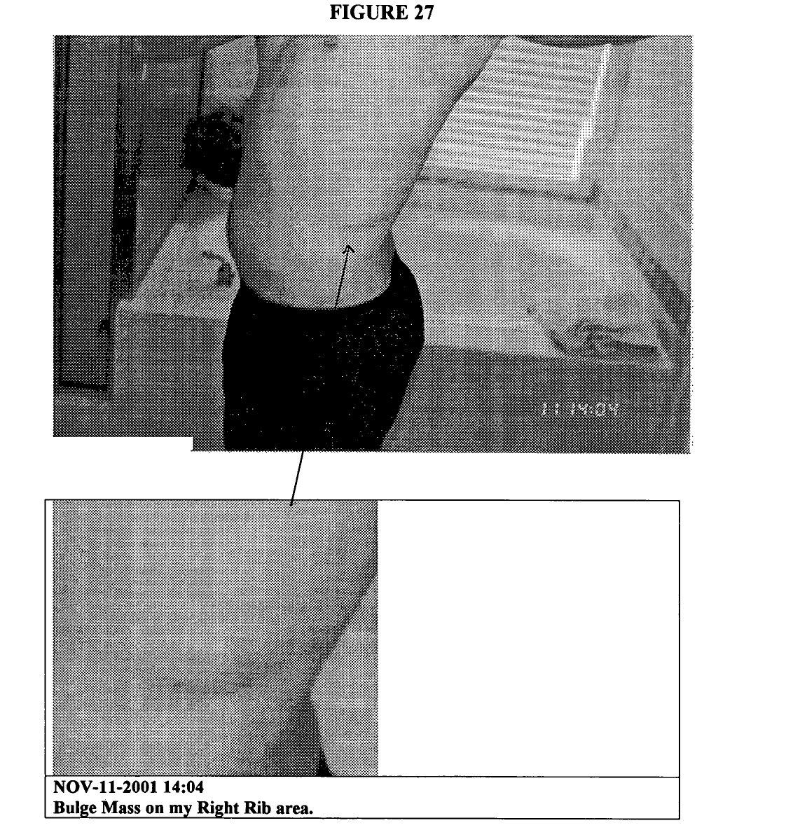

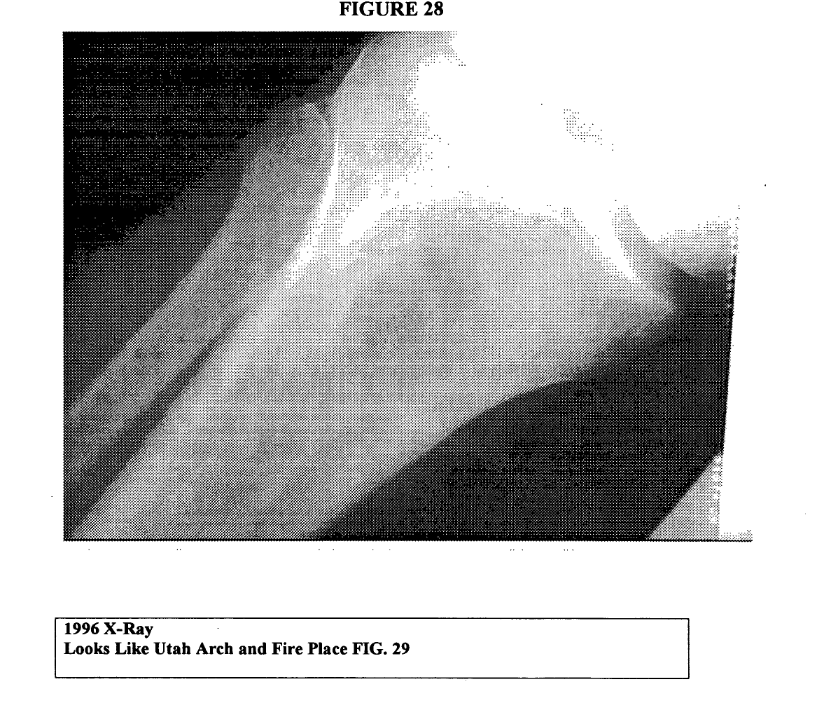

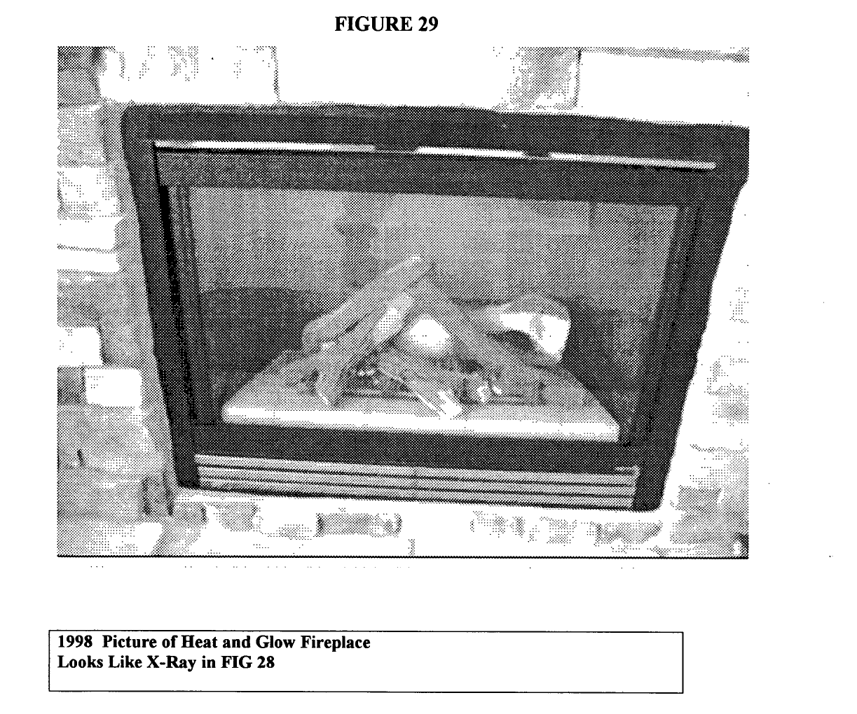

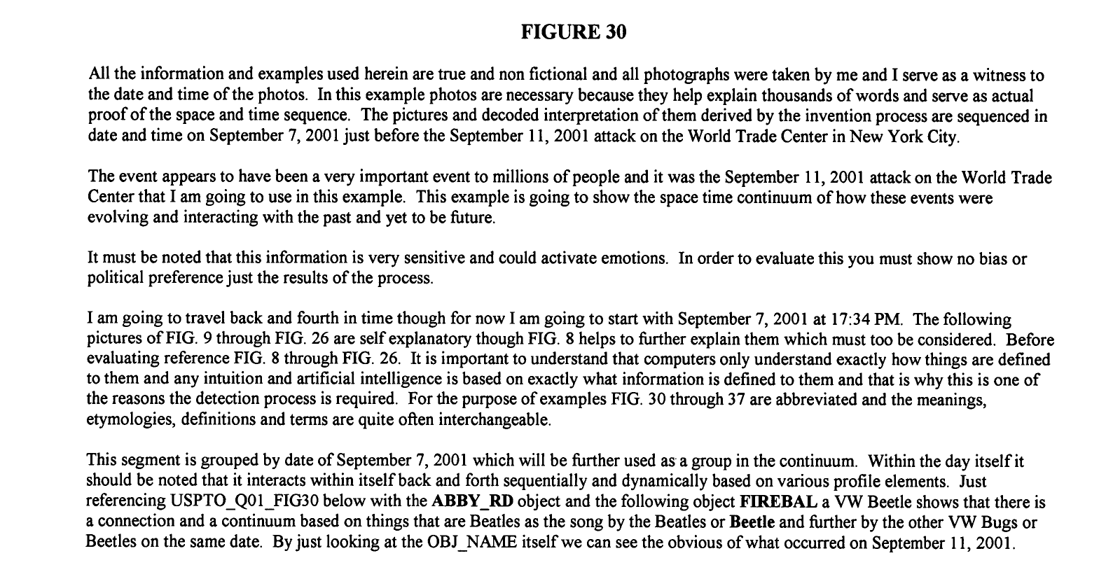

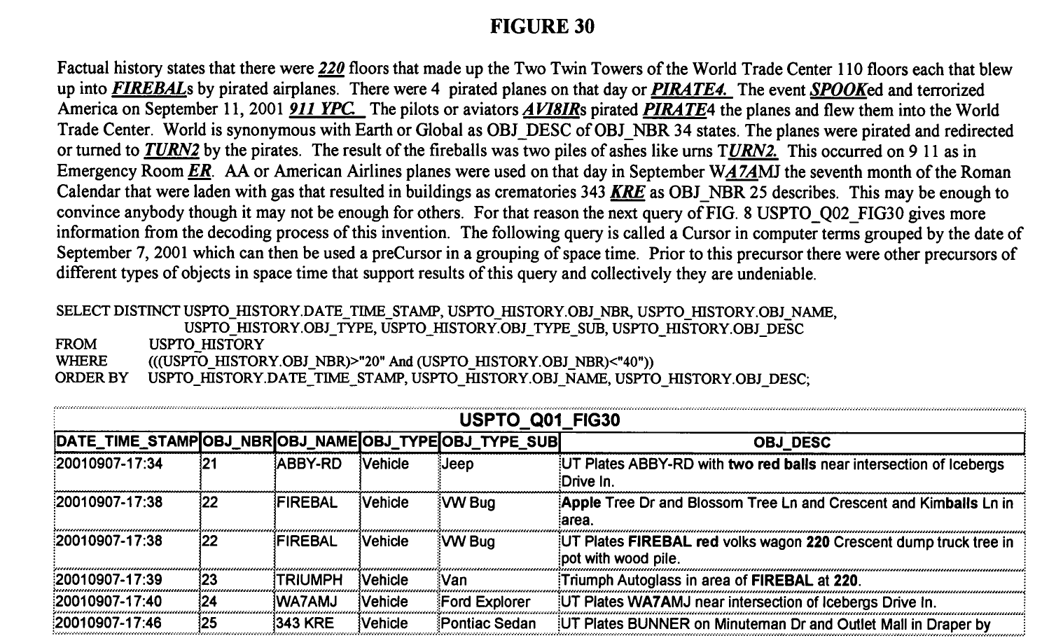

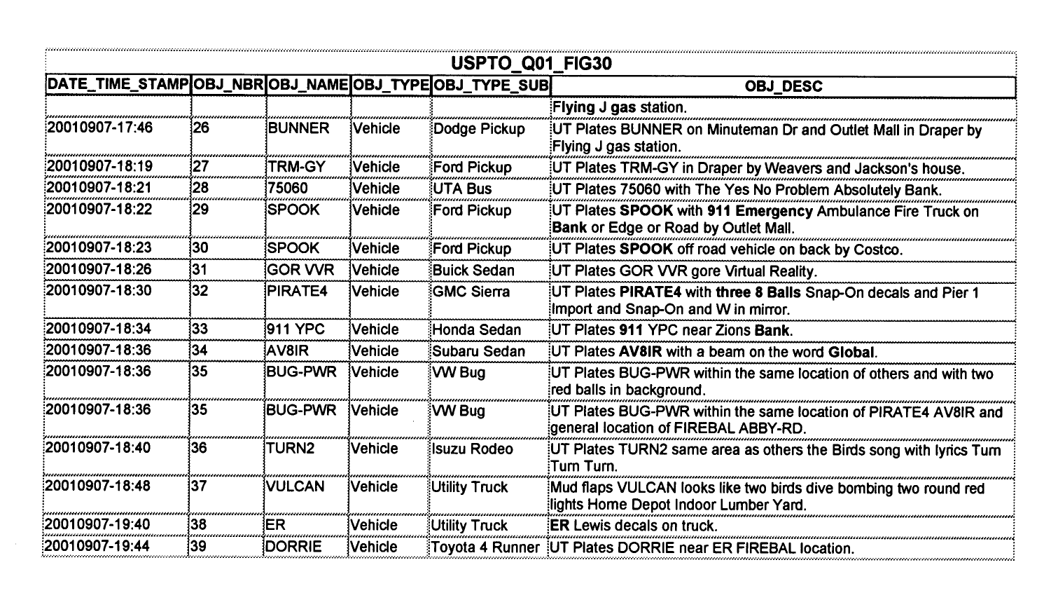

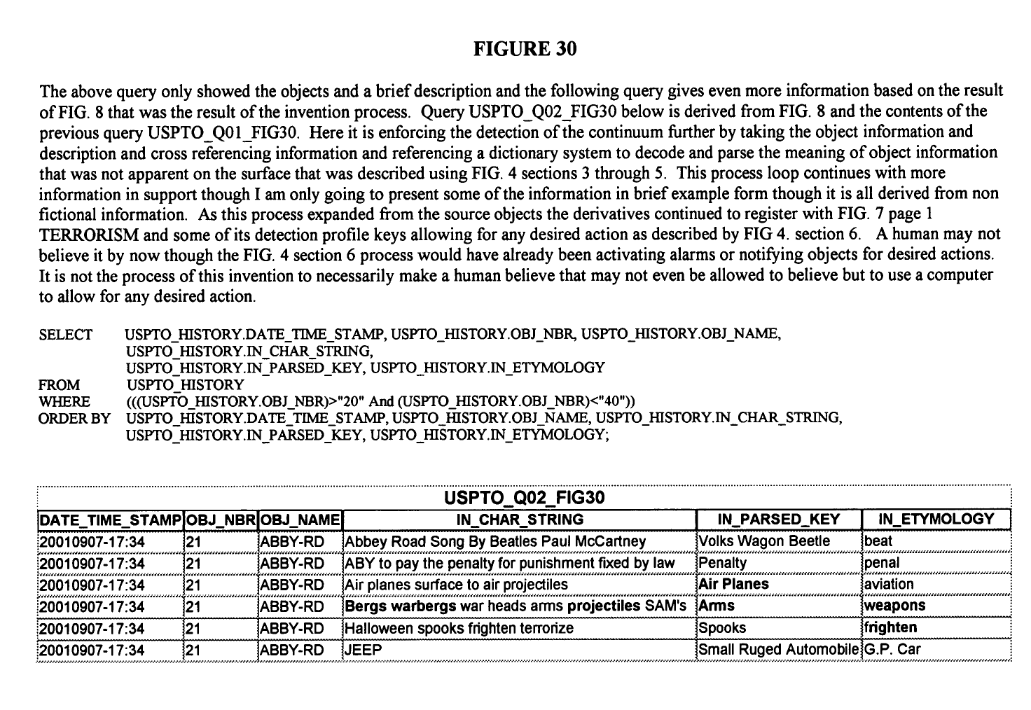

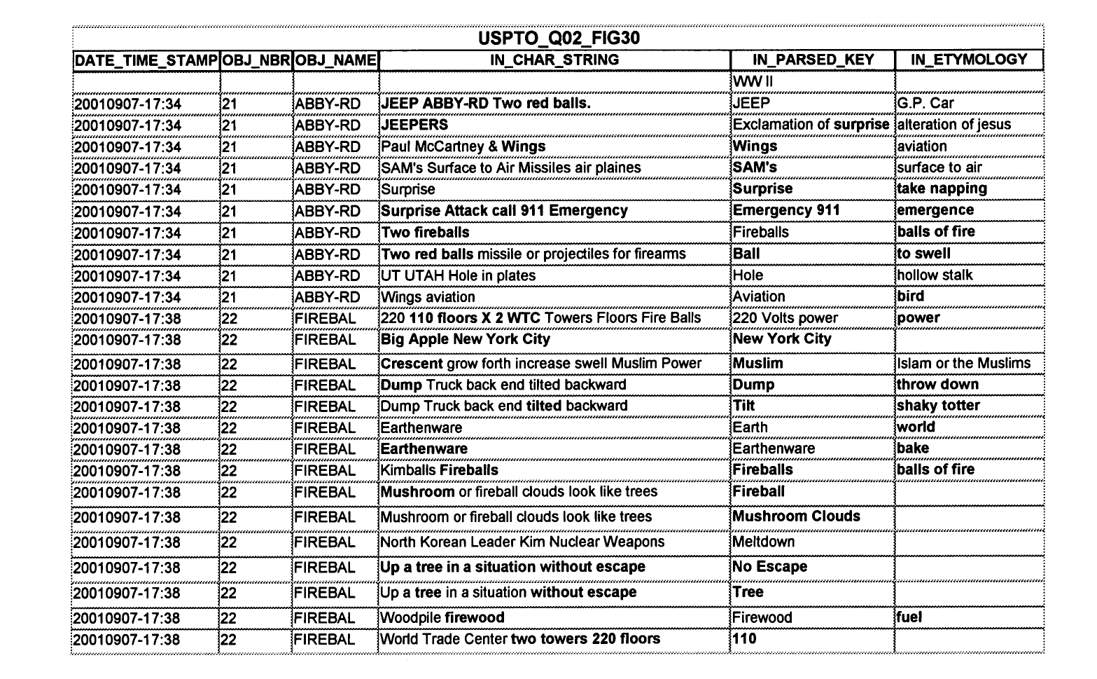

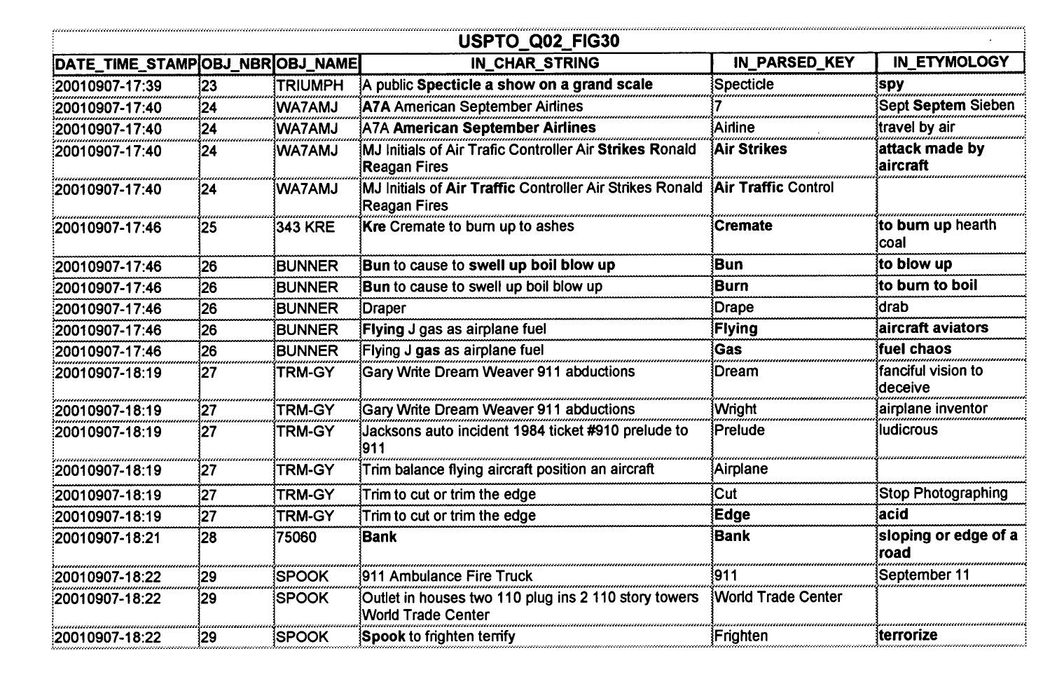

2. FIG. 8 shows what the history file information could look like after some information has been entered into the history file as described above. This example is only going to show a small amount of records though an infinite amount of information could be stored.

3. FIG. 4 process 5 shows that for each record generated from FIG. 4 sub processes 4.1 through 4.9 a record is written to storage and as each record written to storage occurs then FIG. 4 sub process 6 the Monitoring Reporting and Analysis Routine is initiated.

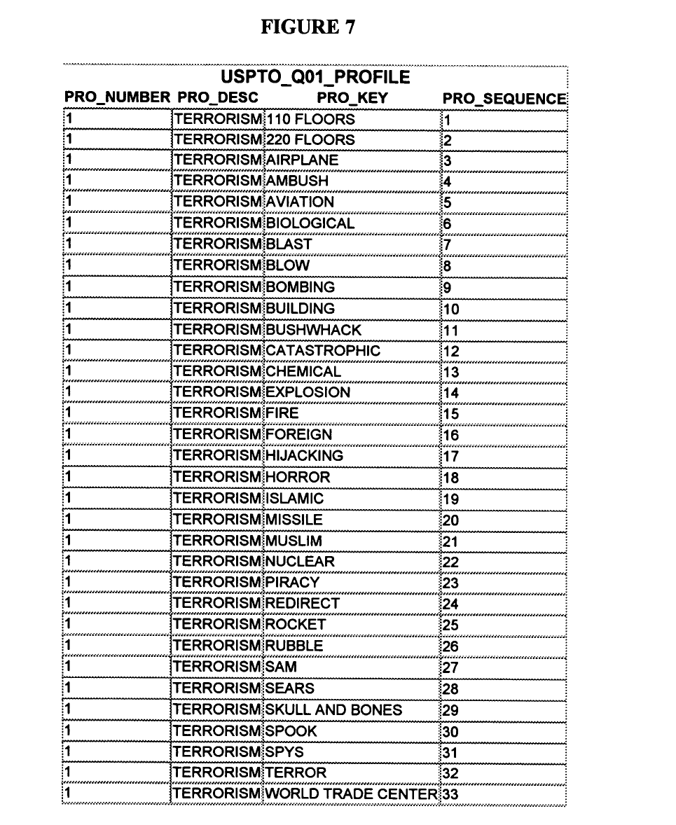

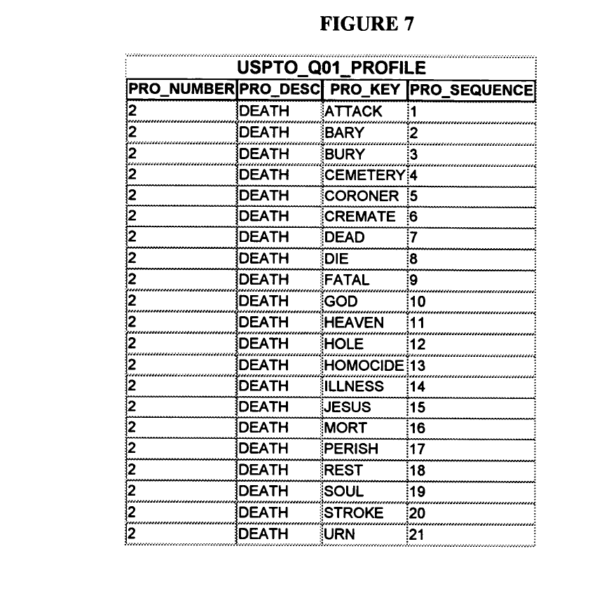

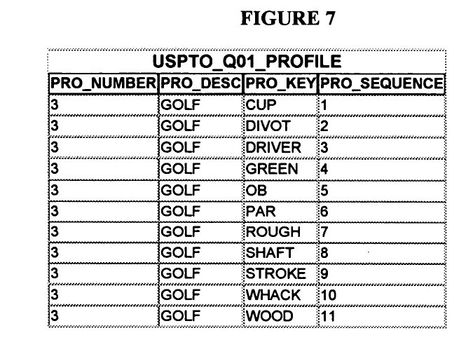

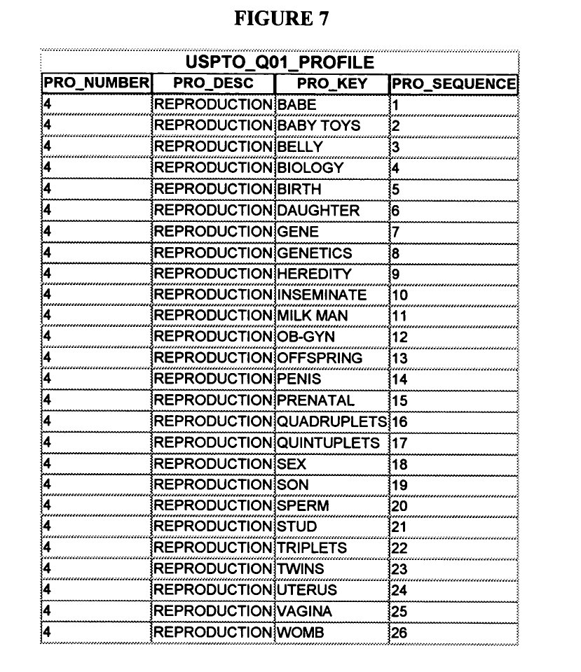

4. FIG. 7 shows what the profile file information could look like that is continuously monitoring for an automated notification if automated notification is desired matching profile factors to history file FIG. 8 factors when action event correlations occur.

5. The previous steps in this section the Detailed Description of the Invention show how this process works. The following will show examples of how this process actually does work and has proven to work on numerous examples. The thing that is different about this invention than other possible inventions that have activations for things that might occur is that this invention will show examples of things that will occur in the future and have been based on a past and a present allowing for the Space Time Continuum Interception Detection System to work. I am only going to show a few examples to prove that this invention actually does work.

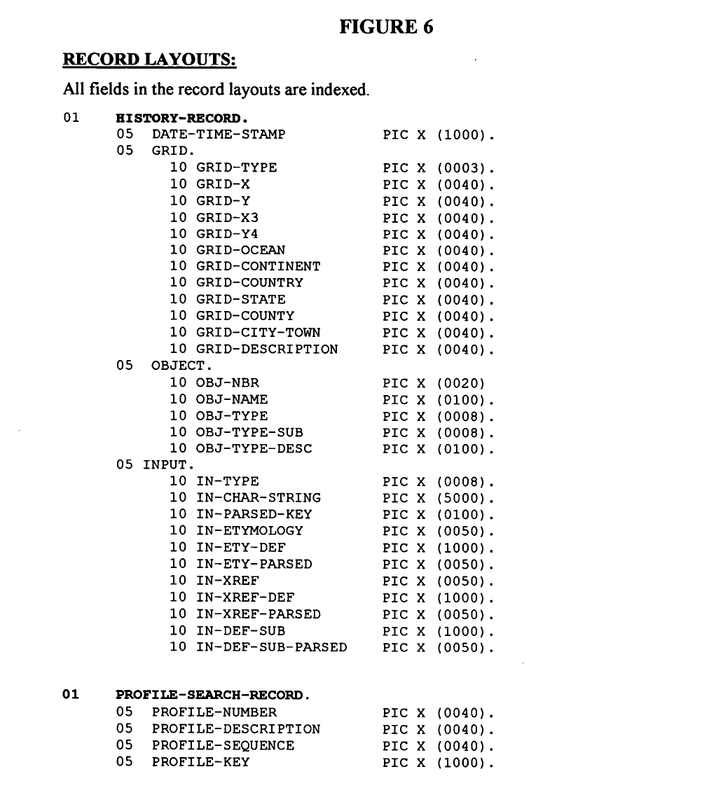

6. FIG. 8 shows the result of a database file of History information mapping it to FIG. 6 of the record format.

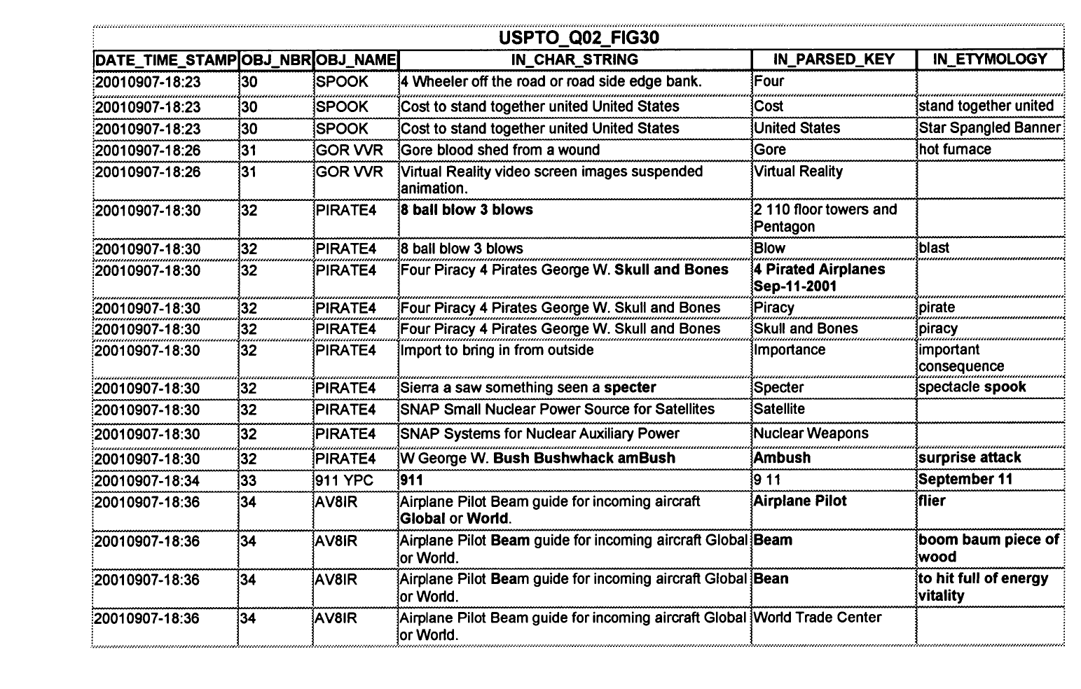

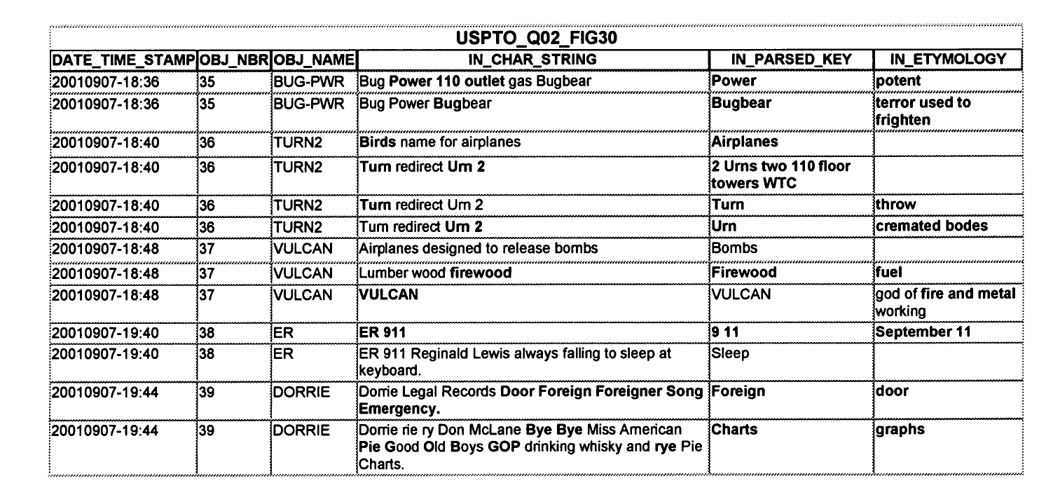

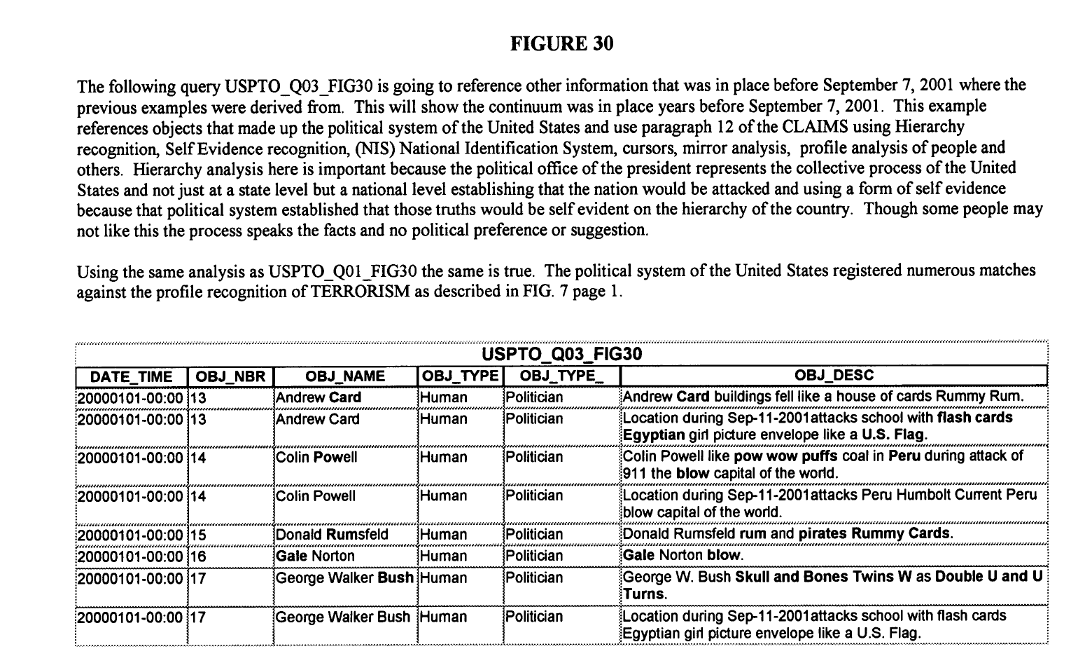

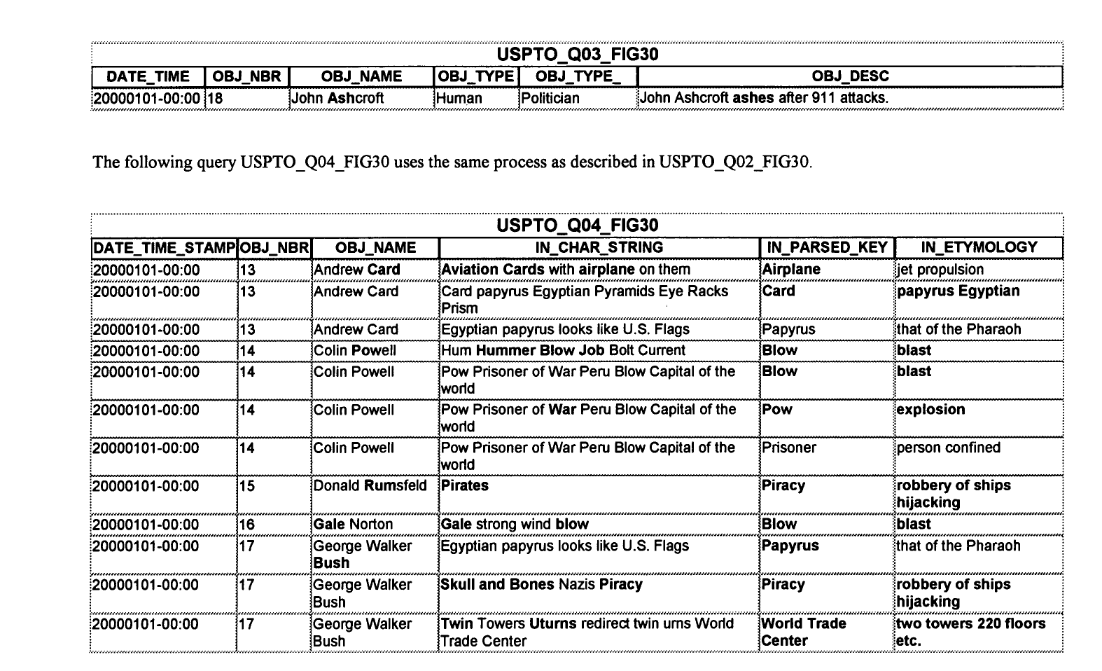

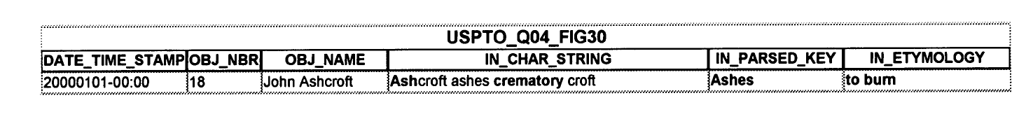

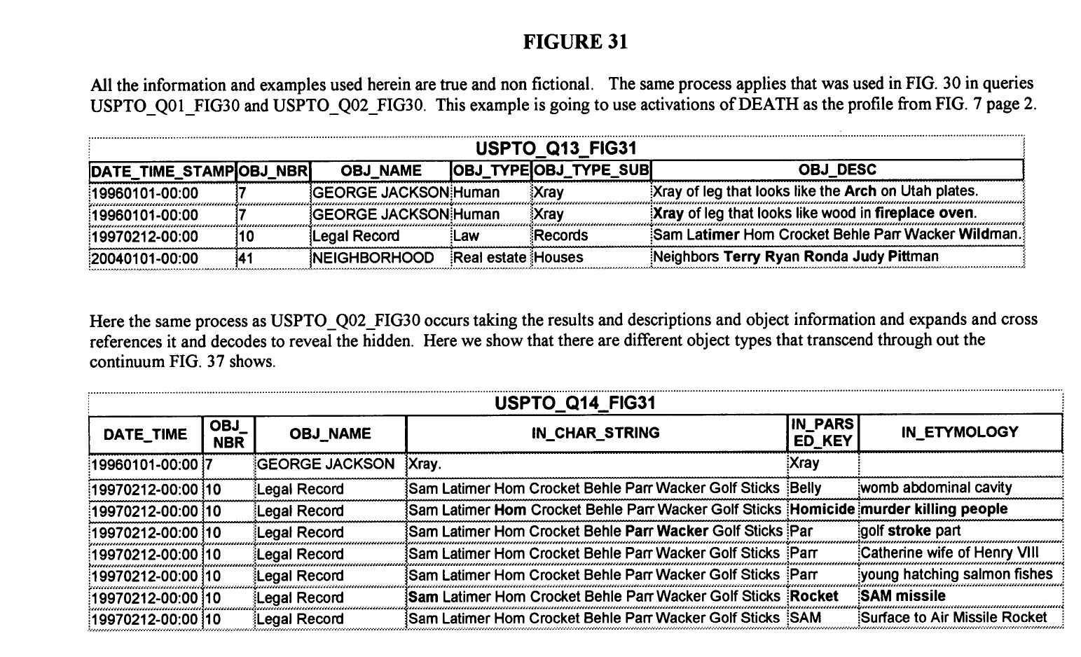

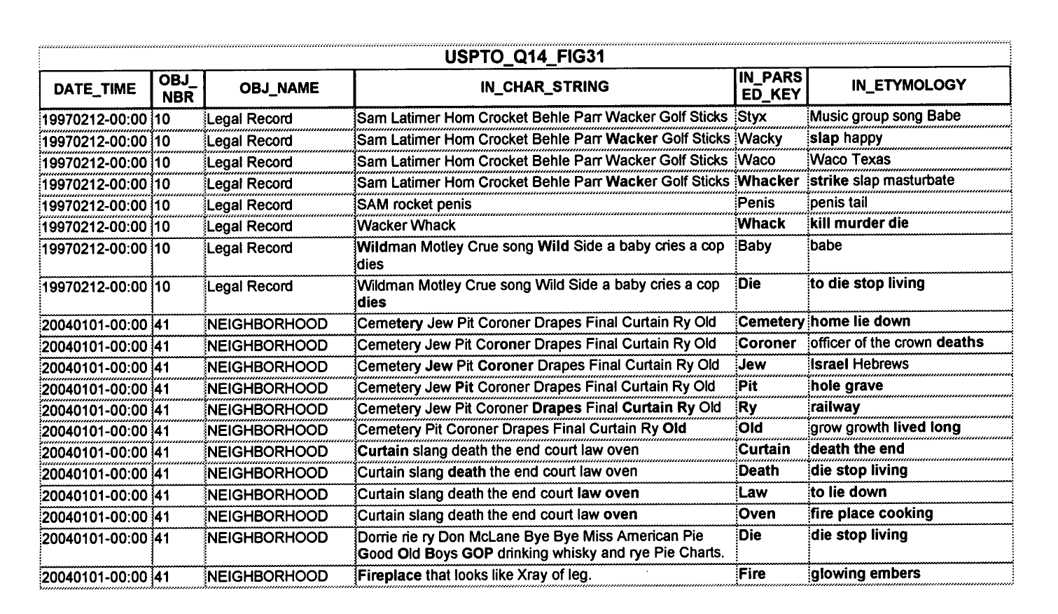

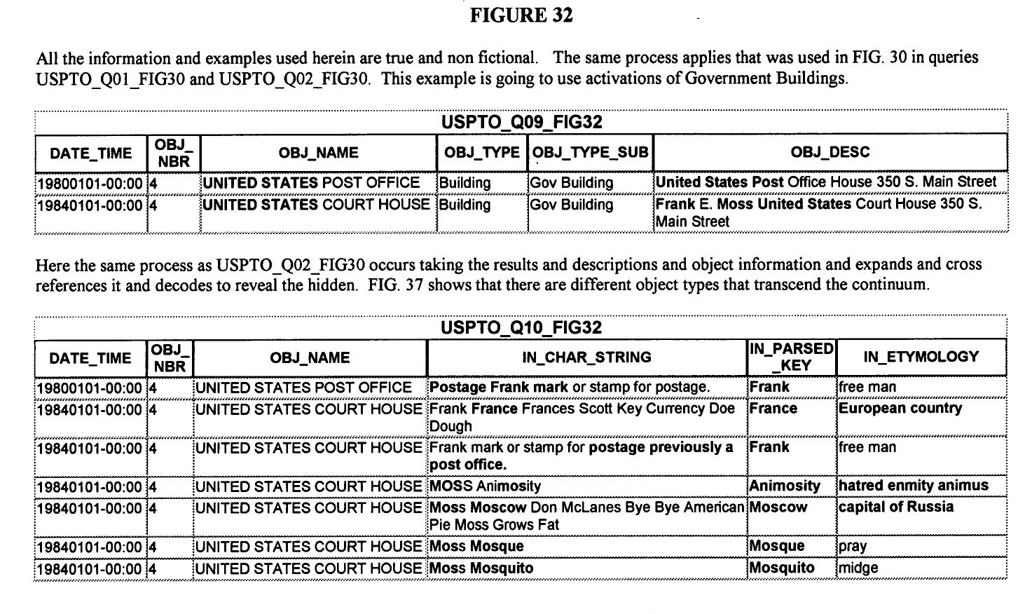

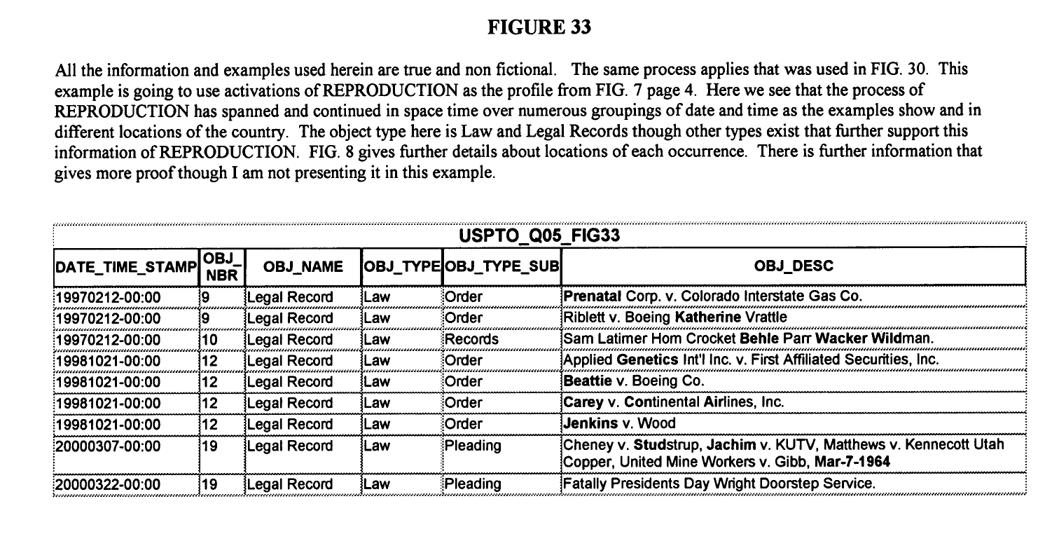

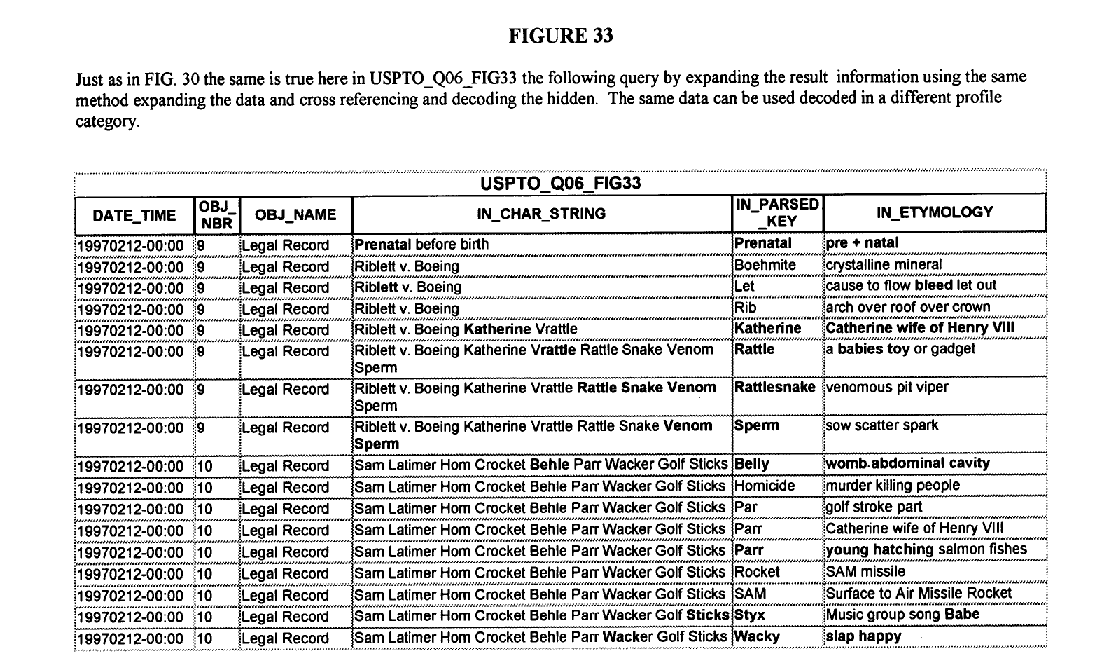

7. FIG. 8 information is the result of a computer database used to store the information. The result of FIG. 8 was done with use of human and automated input processes. History and real time information was entered. FIG. 8 file results were made up of a combination of the items stated on paragraph 9 and 10 of the CLAIMS and FIG. 30-37 shows how elements of paragraph 9 and 10 of the CLAIMS were used to produce FIG. 8. This invention does not claim to invent paragraph 9 9.1 through 9.28 and 10 10.1.1 through 10.1.8 elements of the CLAIMS though it does claim to use information derived from them to be used as input to paragraph 10.4 through 10.5 and 11 of the CLAIMS. The contents of FIG. 8 are kept small and abbreviated for evaluating this invention because the file could be very large.

8. FIG. 8 contents definitions, cross references, etymologies are quite often synonymous and were derived using human input and a electronic dictionary that allows for automatic cross reference of the elements of information that make up the records in the file.

9. FIG. 7 shows the result of a database file of Profile information mapping it to FIG. 6 of the record format.

10. FIG. 7 shows elements that are to be detected as they appear in the result of FIG. 8 allowing for a desired action when the conditions match.

11. FIG. 30 shows true results of information that was derived from true actual events and actions that did occur in an interactive series of past present and future actions and events in a space time continuum and how claims of this invention were used referencing a combination of information described in paragraph 9 of the CLAIMS.

12. FIG. 31 shows true results of information that was derived from true actual events and actions that did occur in an interactive series of past present and future actions and events in a space time continuum and how claims of this invention were used referencing a combination of information described in paragraph 9 of the CLAIMS.

13. FIG. 32 shows true results of information that was derived from true actual events and actions that did occur in an interactive series of past present and future actions and events in a space time continuum and how claims of this invention were used referencing a combination of information described in paragraph 9 of the CLAIMS.

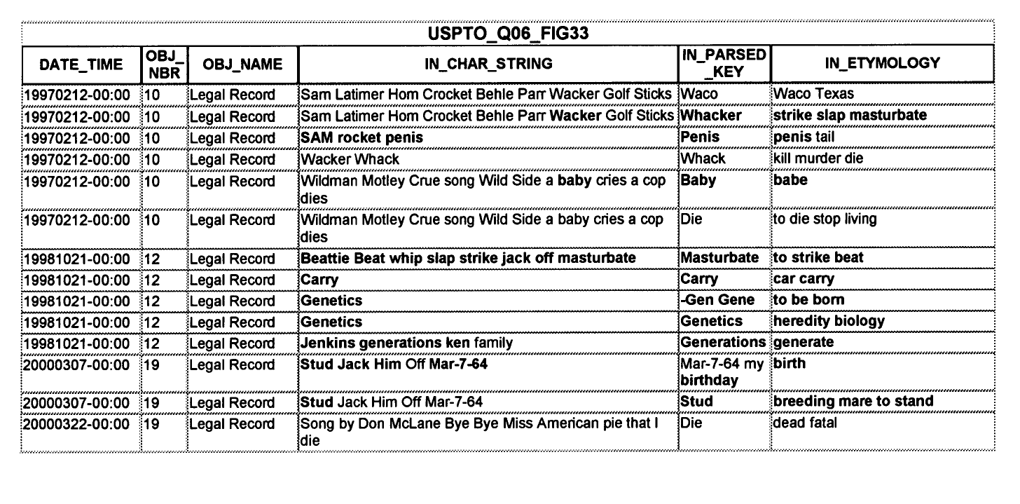

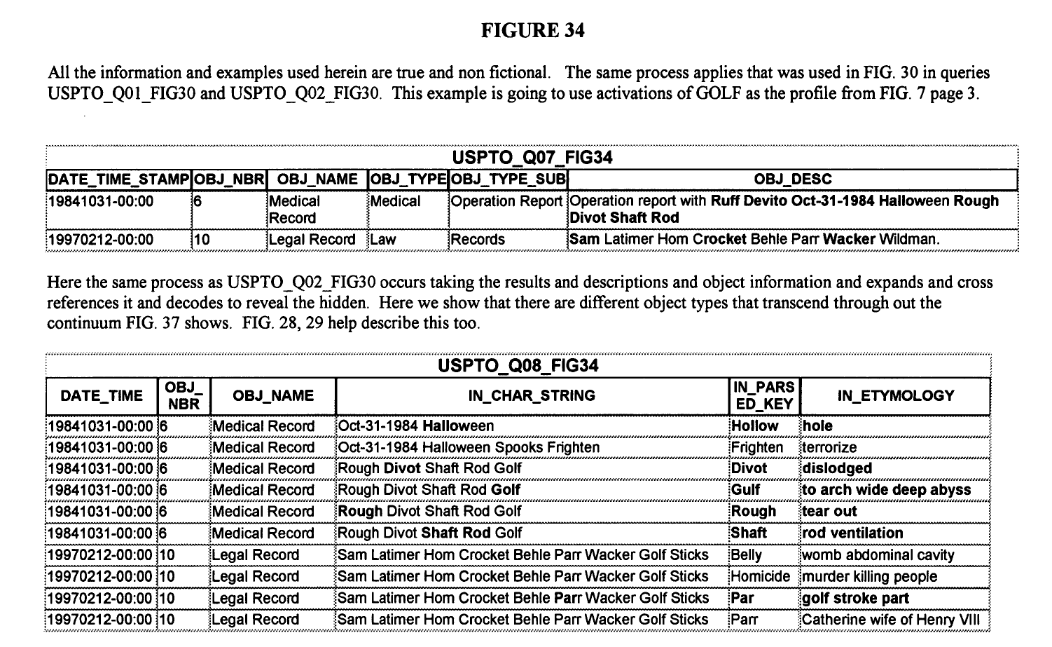

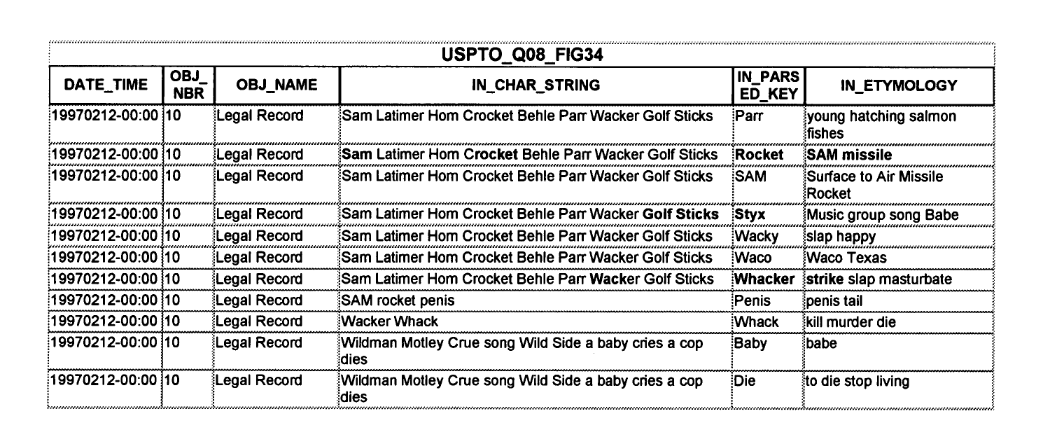

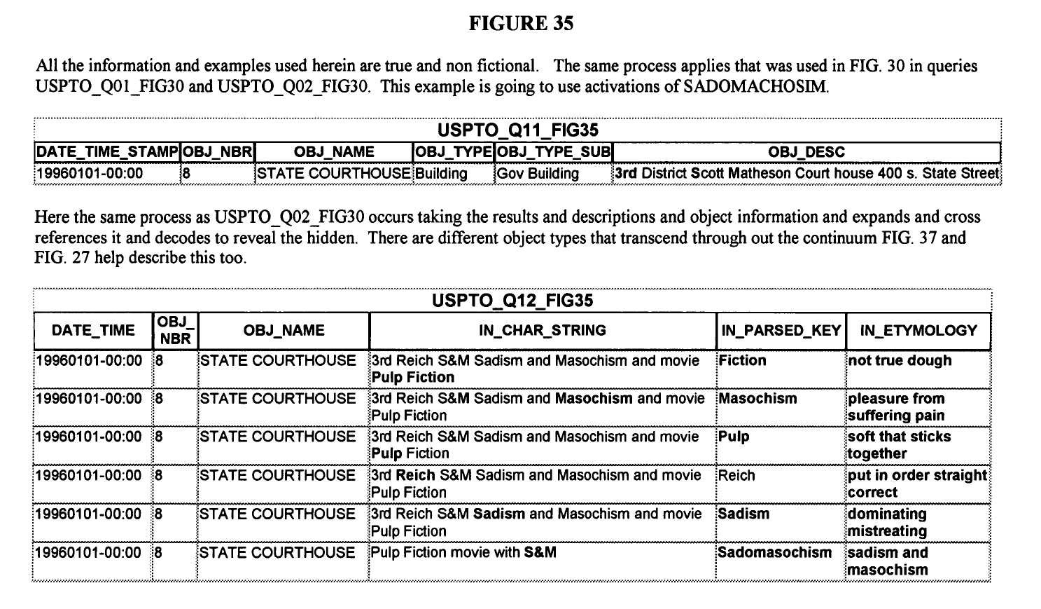

14. FIG. 33 shows true results of information that was derived from true actual events and actions that did occur in an interactive series of past present and future actions and events in a space time continuum and how claims of this invention were used referencing a combination of information described in paragraph 9 of the CLAIMS.

15. FIG. 34 shows true results of information that was derived from true actual events and actions that did occur in an interactive series of past present and future actions and events in a space time continuum and how claims of this invention were used referencing a combination of information described in paragraph 9 of the CLAIMS.

16. FIG. 35 shows true results of information that was derived from true actual events and actions that did occur in an interactive series of past present and future actions and events in a space time continuum and how claims of this invention were used referencing a combination of information described in paragraph 9 of the CLAIMS.

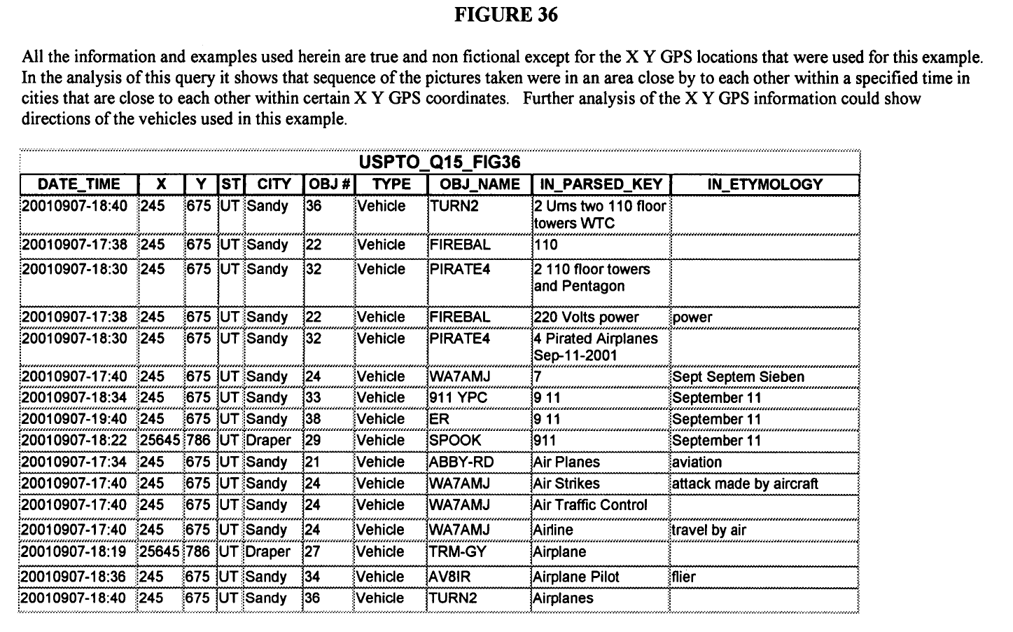

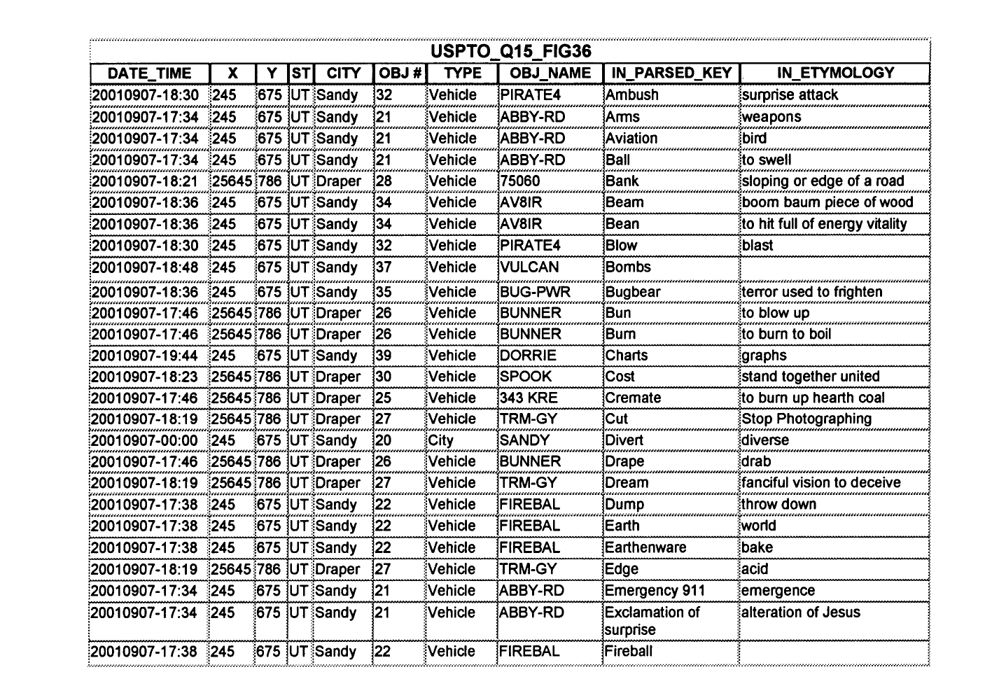

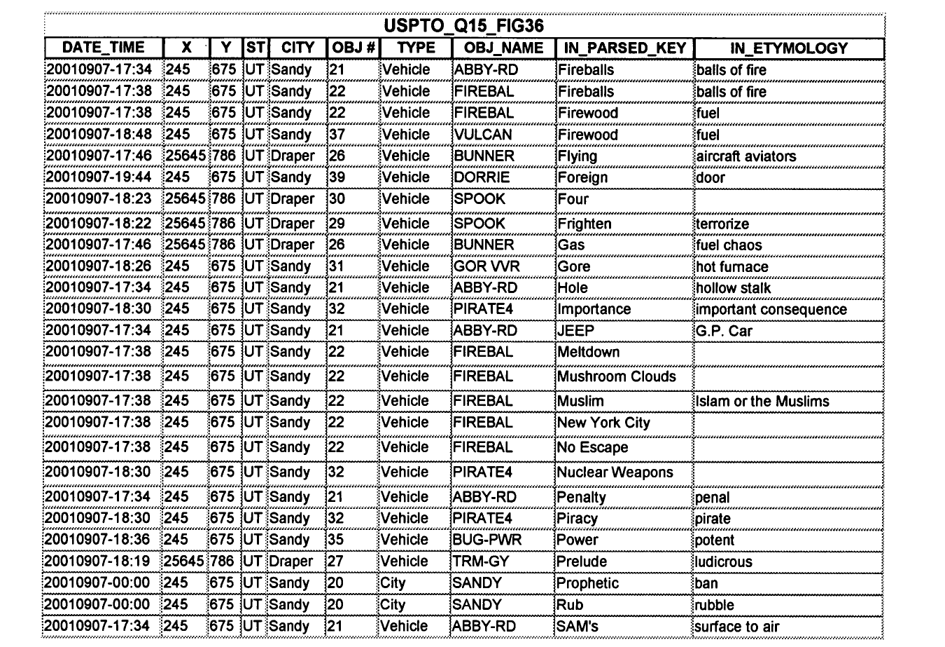

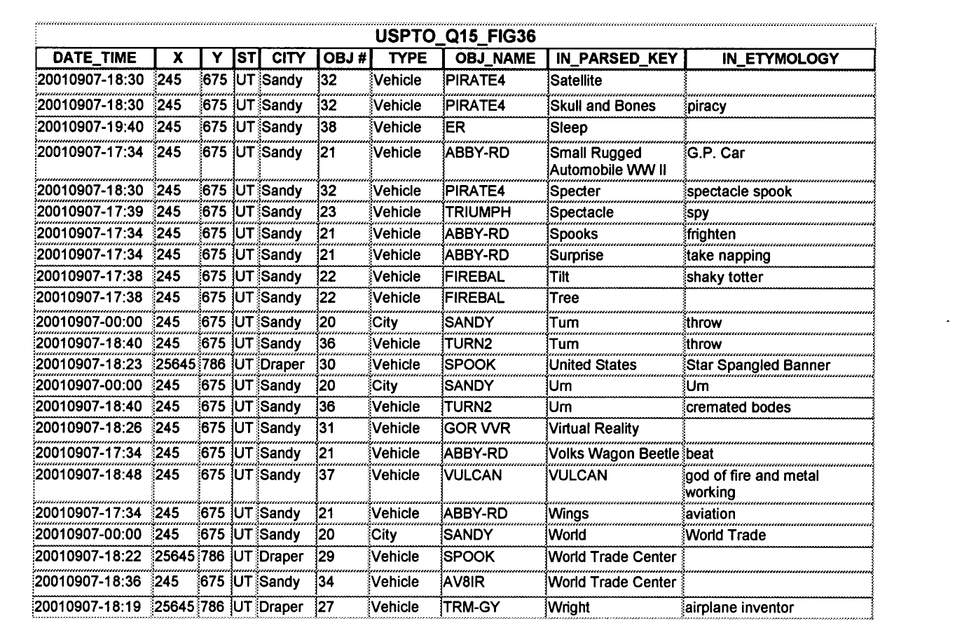

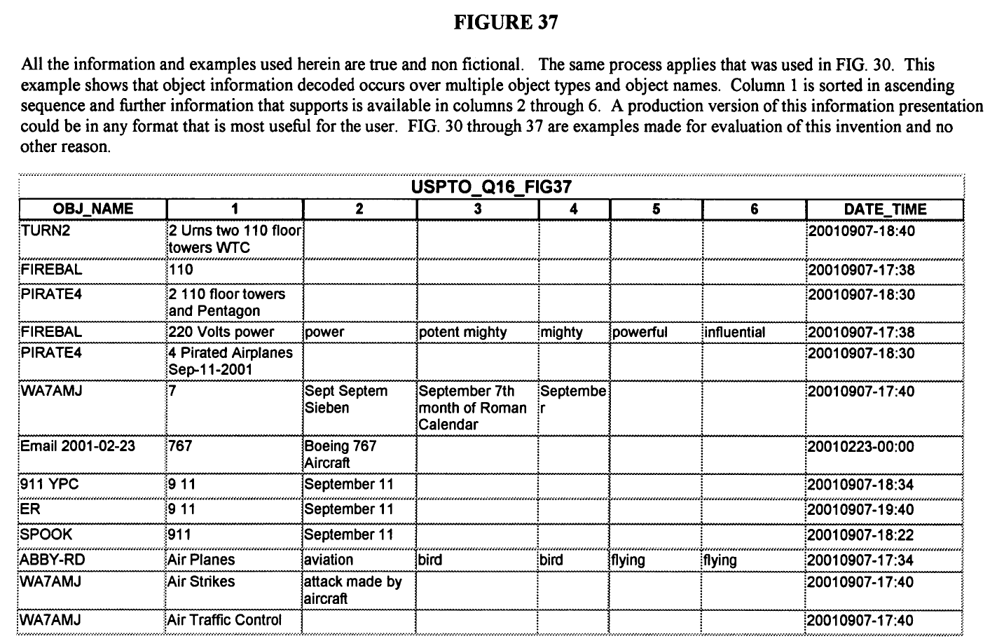

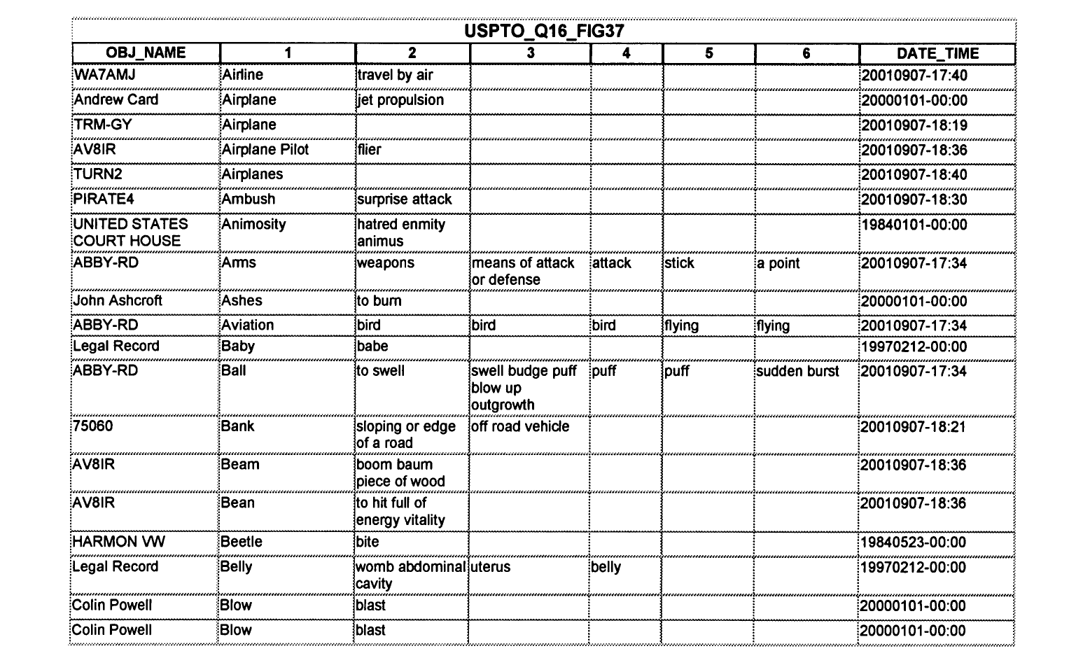

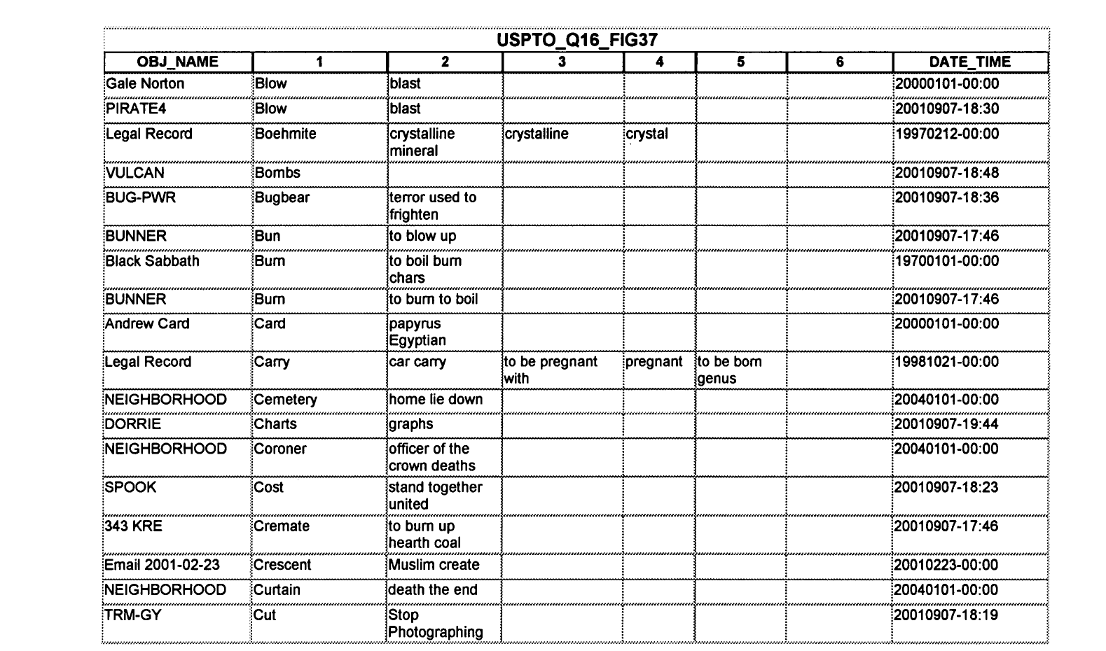

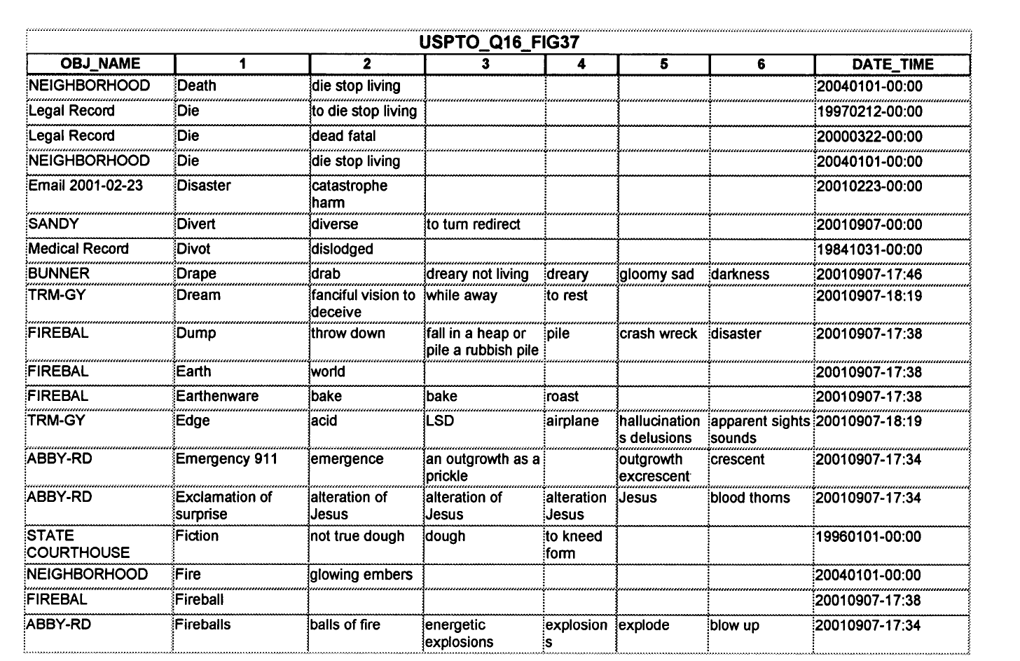

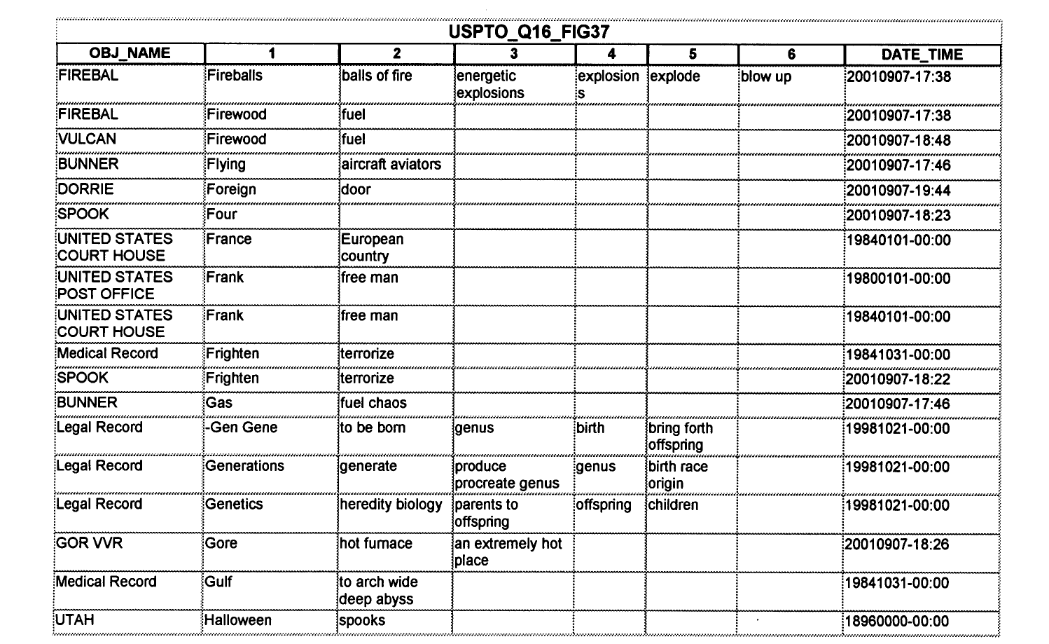

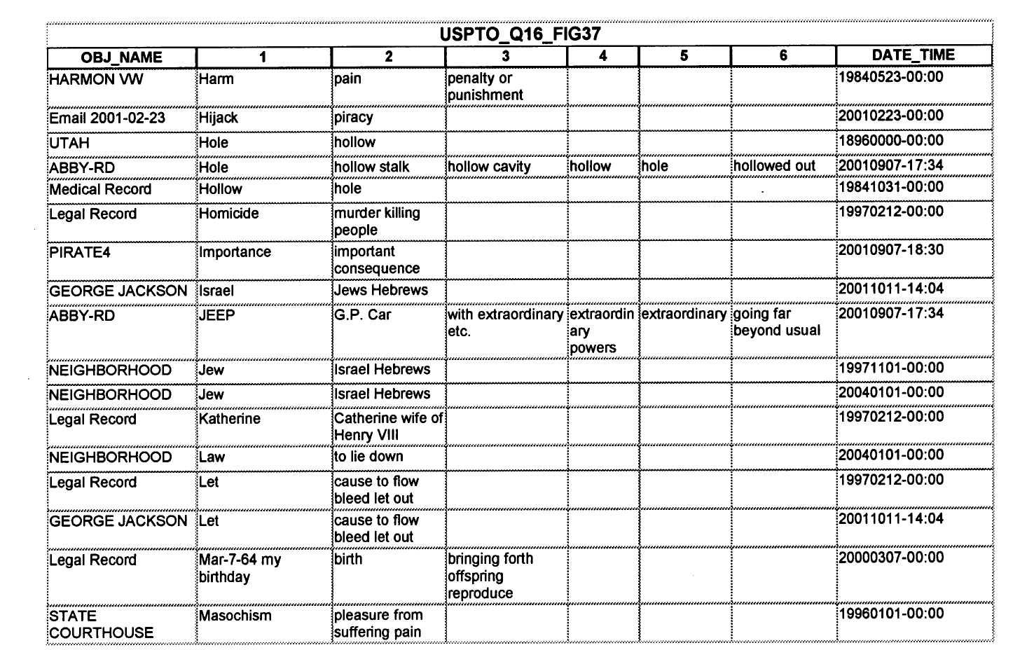

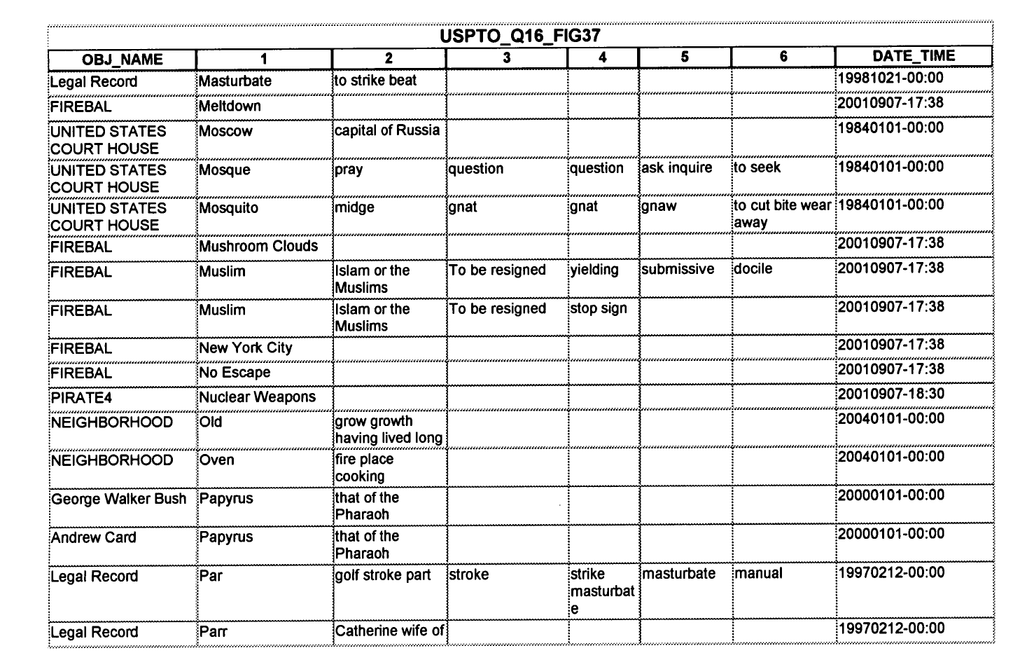

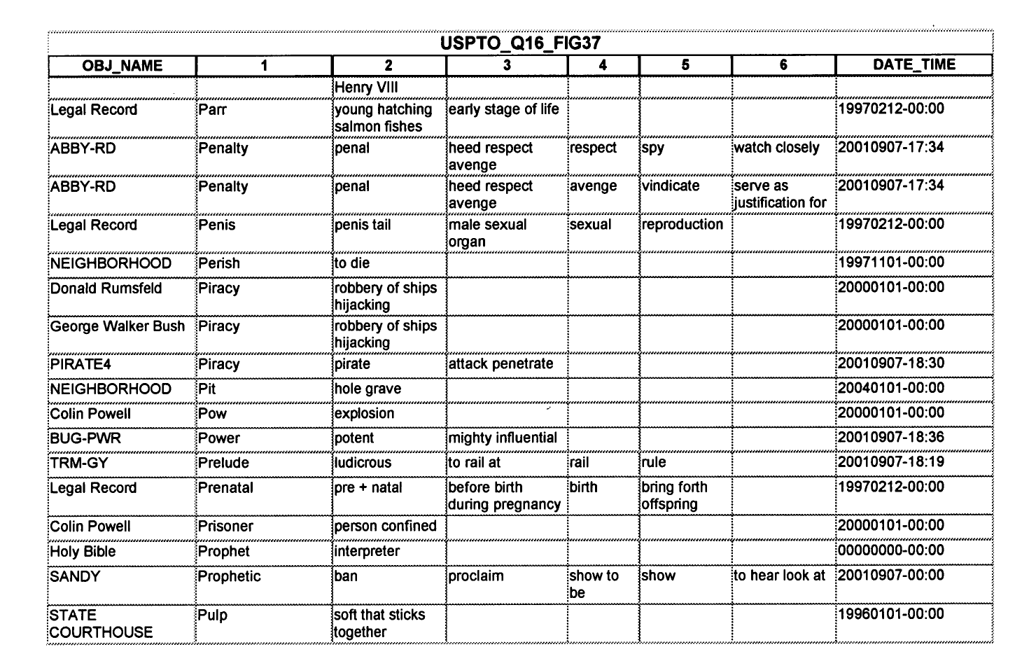

17. FIG. 36 shows true results of information that was derived from true actual events and actions that did occur in an interactive series of past present and future actions and events in a space time continuum and how claims of this invention were used referencing a combination of information described in paragraph 9 of the CLAIMS.

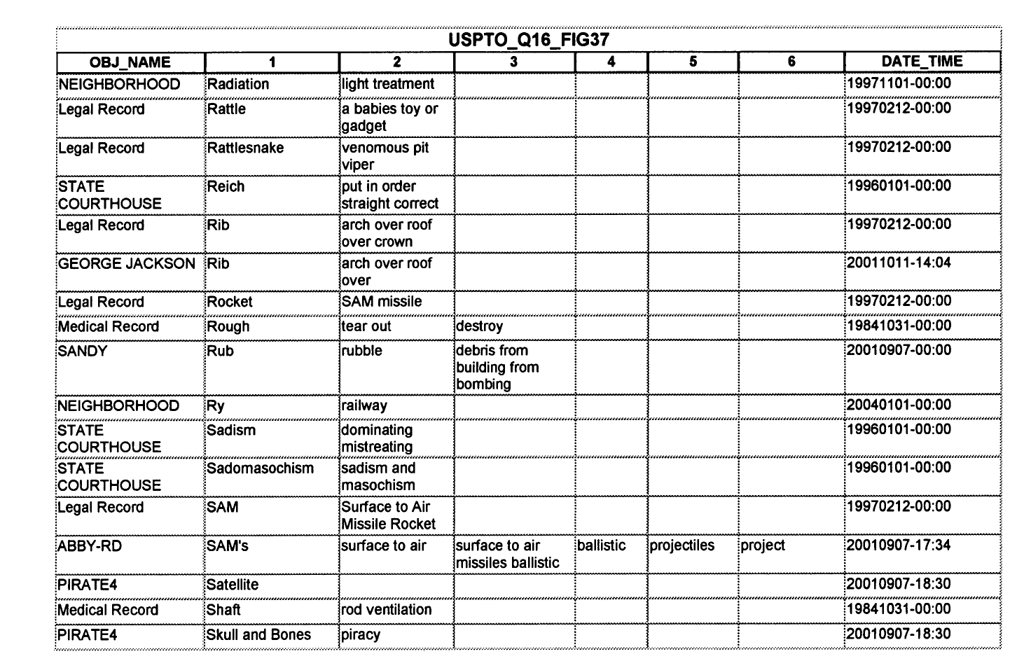

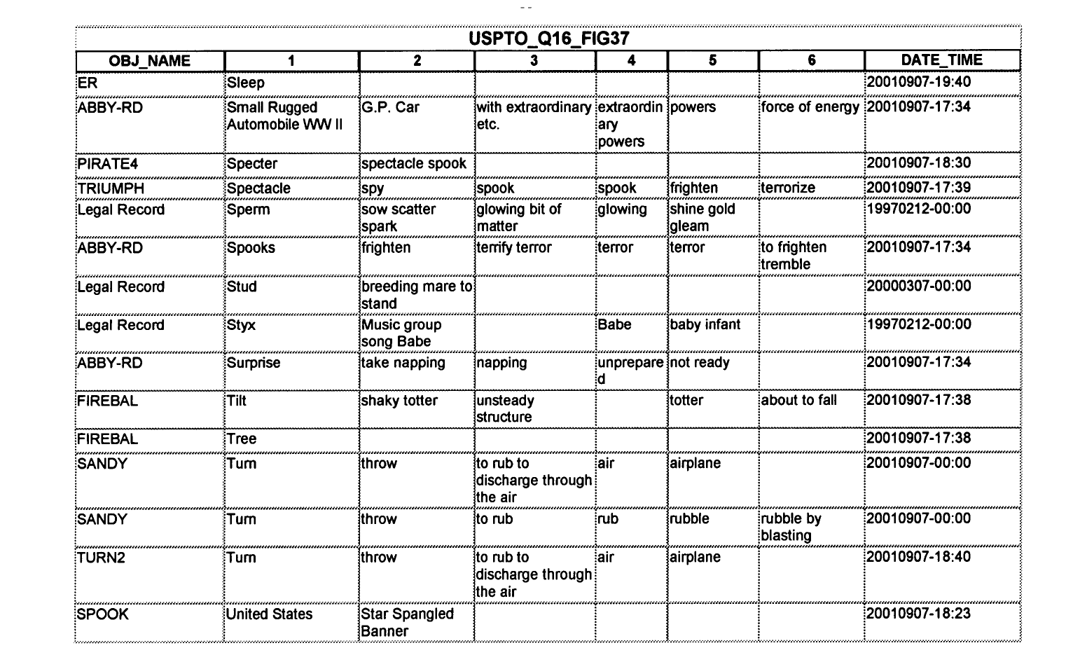

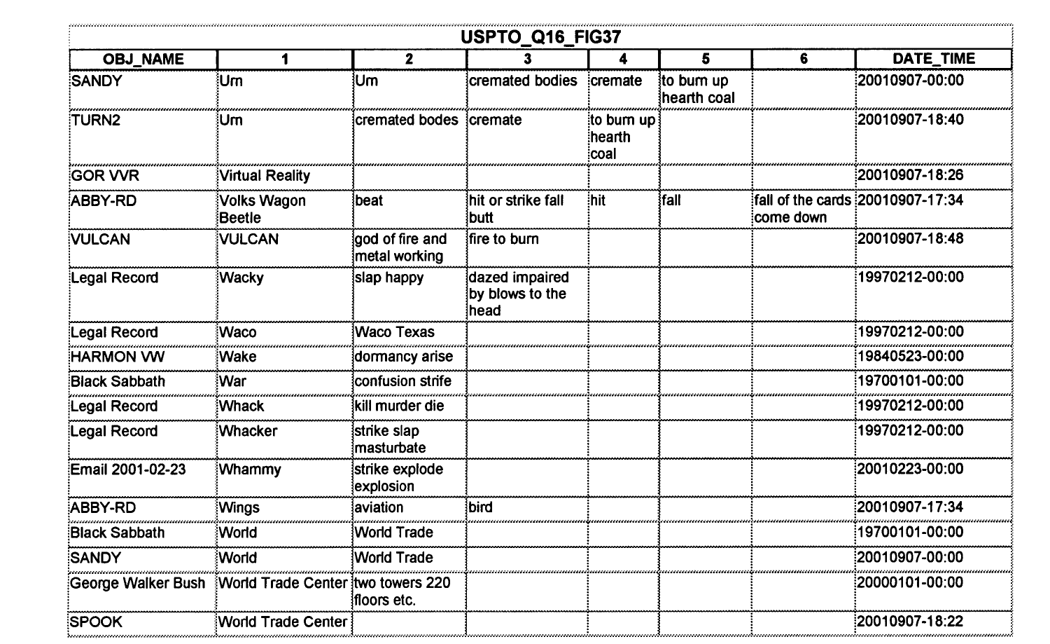

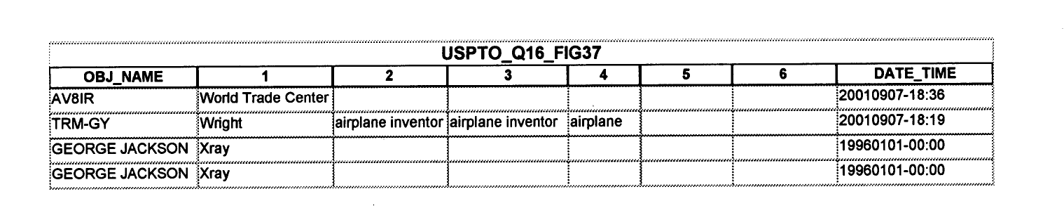

18. FIG. 37 shows true results of information that was derived from FIG. 30-36 in a summary form indicating that a continuum spanning various object types in various places in space time enforcing same results.

What I claim as my invention is:

1. A new process for a space time continuum intercept detection system that interacts with the past, present and future using factual and real life objects, actions and events in space and time to detect past, present and future events and actions allowing for desired actions.

2. The process of claim 1 where computers are used to process the result.

3. This process of claim 1 allows for it to be run on any capable computer operating system and language and hardware with any chosen files and database formats and capable application software.

4. The process of claim 1 where humans are used to process the result with or without computers.

5. The process of claim 1 allows for new information via input output automated processes and or human or other interaction allowing for continuous information collection and analysis.

6. The process of claim 1 works with as little as a one object or history record entered manually with human interaction or with an infinite amount of objects and history entered with external automated processes such as optical character and pattern readers or electronic file loading of the files or database.

7. The process of claim 1 obtains the date and time of objects in space and time where the date and or time are available and using the following:
7.1. Date Time Stamps from Atomic clocks source;
7.2. Synchronize input of Date and Time on file with Atomic Clock Date Time;

8. The process of claim 1 maps the location of the object where the location is available using the following where X Y are the X Y coordinates and X3 Y4 are the third and fourth dimensions:
8.1. Universal location of X Y X3 Y4 dimension coordinates and description;
8.2. Galaxy location of X Y X3 Y4 dimension coordinates and description;
8.3. Solar System location of X Y X3 Y4 dimension coordinates and description;
8.4. Celestial location of X Y X3 Y4 dimension coordinates and description;
8.5. Terrestrial location of X Y X3 Y4 dimension coordinates and description;

9. The process of claim 1 obtains information about the object in space in time where the information is available using any combination of the following:
9.1. Accesses object information;
9.2. Business objects, records and its contents;
9.3. Communications objects, records and its contents;
9.4. Education objects, records and its contents;
9.5. Email, letters, notes, things written or translated to the English language objects, records and its contents;
9.6. Employment objects, records and its contents;
9.7. Energy objects, records and its contents;
9.8. Entertainment objects, records and its contents;
9.9. Financial objects, records and its contents;
9.10. Food objects, records and its contents;
9.11. Governments national and international objects, records and its contents;
9.12. Healthcare objects, records and its contents;
9.13. International objects, records and its contents;
9.14. Inserts new information about object into storage if not already stored;
9.15. Media objects, records and its contents;
9.16. Law objects, records and its contents;
9.17. Legal objects, records and its contents;
9.18. News objects, records and its contents;
9.19 Personal objects, records and its contents;
9.20. Political objects, records and its contents;
9.21. Publications objects, records and its contents;
9.22. Radio objects, records and its contents;
9.23. Research objects, records and its contents;
9.24. Real estate objects, records and its contents;
9.25. Traffic objects, records and its contents;
9.26. Transportation objects, records and its contents;
9.27. Unknown and other objects, records and its contents later to be categorized;
9.28. Web page objects, records and its contents;
9.29. The result of this invention objects, records and its contents;

10. The process of claim 1 uses a recognition system loop process until designated levels of information are accumulated for the object being processed using any combination of the following:
10.1 Input System;
10.1.1. Audio and Visual;
10.1.2. Five senses of Sight, Taste, Smell, Hearing, Touch;
10.1.3. Chemical and Biological detection;
10.1.4. Electromagnetic spectrum wave lengths of radio, light and pulse detection;
10.1.5. Action and Gesture detection;
10.1.6. Thought and Neuro Muscular detection;
10.1.7. Human Interaction and Data Entry;
10.1.8. Other Interaction and Data Entry;
10.2. Translate 10.1 to electronic source via human or other interaction or electronic process;
10.3. Translate electronic 10.2 storage into readable character strings, encrypted and patterned code;
10.4. Parse 10.3 into words, morpheme, abbreviations, initials, syllables, letters and phonetics;
10.5. Reference dictionary systems for matching keywords, keys, sounds, sounds like, looks like, contains, rhymes, past present and future tense and numerology data and information;

11. The process of claim 10.5 stores each recognizable item until the recognition process is completed using the following:
11.1. Write record to storage be it electronic or hard copy.
11.2. Initiates monitoring reporting and analysis routine claim 12.

12. The process of claim 11 is evaluated as each new item is stored and the monitoring reporting and analysis process is activated based on human analysis and or automated recognition profile driven procedures allowing for querying pattern recognition using the combination of any of the following:
12.1. Activates alarm process notifying and taking necessary action;
12.2. AIS Alien Identification System profile analysis;
12.3. Artificial Intelligence to produce result;
12.4. Color and shade analysis;
12.5. Correlated query analysis;
12.6. Cursors and Precursor query analysis;
12.7. Detect past, present and future actions;
12.8. Elimination analysis;
12.9. Grouping and Categorizing;
12.10. Hierarchy recognition;
12.11. Mirror recognition to any object or objects that are part of a grouping;
12.12. NIS National Identification System profile analysis of people;
12.13. Pattern analysis;
12.14. Query analysis;
12.15. Self Evidence recognition.
12.16. Sequencing by date and time or other variables;
12.17. Take any desired action from the result;
12.18. X Y X3 Y4 dimensions coordinates and surrounding expansion analysis;
